(19) United States
(12) Patent Application Publication
(10) Pub. No.: US 2003/0147678 A1
(43) Pub. Date: Aug. 7, 2003

(54) Image forming apparatus

(76) Inventors: Yoshio Ozawa, Watarai-gun (JP); Hidehisa Konishi, Watarai-gun (JP)

Correspondence Address: SCHULTE ROTH & ZABEL LLP, ATTN: JOEL E. LUTZKER, 919 THIRD AVENUE, NEW YORK, NY, 10022, US

(21) Appl. No.: 10/280,134

(22) Filed: Oct. 24, 2002

(30) Foreign Application Priority Data
Oct. 26, 2001 (JP) 2001-329393
Dec. 3, 2001 (JP) 2001-368742
Dec. 6, 2001 (JP) 2001-372615
Dec. 25, 2001 (JP) 2001-392005
Dec. 27, 2001 (JP) 2001-398474

(51) Int. Cl. G03G 15/01

(52) U.S. Cl. 399/302

(57) ABSTRACT

An image forming unit 41-44 are disposed along a primary transfer part. A transporting pathway of the primary transfer part is inclined upwardly in the direction from the image forming unit 41 to the image forming unit 44. An intermediate transfer belt is driven by a driving roller 46 and applied with a tension by a supporting roller 47. A backup roller 48 opposes a transfer roller. An intermediate transfer belt unit is composed of the intermediate transfer belt, the driving roller, the supporting roller and the backup roller. A primary transfer part is defined between the driving roller and the supporting roller. The backup roller is disposed vertically under the image forming unit 41 whereby the image forming apparatus becomes compact and a recording medium can be easily separated from the intermediate transfer belt.

### BACKGROUND OF THE INVENTION

1. Field of the Invention

The present invention relates to an image forming apparatus by an electro-photography process such as a copying machine, a printer or a facsimile machine and more particularly to an image forming apparatus which forms images utilizing an endless belt such as an endless intermediate transfer body.

2. Description of the Related Art

Generally, an electro-photographic image forming apparatus (hereinafter referred to as an image forming apparatus) which utilizes an endless belt of an intermediate transfer body (hereinafter referred to as an intermediate transfer belt) when color images are formed by an electro-photography process is known in public. In the image forming apparatus, a plurality of image forming units are disposed along an intermediate transfer belt and a second transfer roller is disposed at the downstream of rotational direction of the intermediate transfer belt.

A conventional image forming apparatus is now explained below as referring to FIG. 1.

The image forming apparatus shown in FIG. 1 has a plurality of image forming units 11-14 each comprising a photosensitive body drum 11a-14a and a toner container 11b-14b. In the figure, each of the image forming units 11, 12, 13 and 14 corresponds to that of yellow (Y), magenta (M), cyan (C) and black (K). These image forming units, more specifically the photosensitive body drums are disposed along the transporting direction of an intermediate transfer belt 21 (a transporting pathway) so that the photosensitive body drum 11a is disposed at the most upstream of the transporting pathway and the photosensitive body drum 14a is disposed at the most downstream of the transporting pathway. Unshown primary transfer rollers are disposed each facing the photosensitive body drums 11a-14a.

The intermediate transfer belt 21 is supported by a driving roller 22a, a supporting roller 22b, a tension roller 23 and a backup roller 24 and is driven in the direction of the solid arrow head (line) by the driving roller 22a while being applied a predetermined tension by the tension roller 23.

The backup roller 24 faces a secondary transfer roller 25. A primary transfer part is defined between the driving roller 22a and the supporting roller 22b along which said image forming units 11,12,13,14 is disposed.

When images are formed, toner images are formed on the photosensitive body drums 11a-14a synchronized with the movement of the intermediate transfer belt 21. Primary transfer images are formed by primarily transferring the toner images on the intermediate transfer belt 21. A recording medium (not shown) is sent from a paper supplying unit 27 to a secondary transferring position by being transported on a recording media transporting belt 29 with a paper reversing roller 28. The recording medium is sandwiched together with the intermediate transfer belt 21 between the backup roller 24 and the secondary transfer roller 25, the toner images (primary transfer images) being secondarily transferred on the recording medium by the secondary transfer roller 25. Subsequently, the recording medium is transported to a fixing device 30 where the images are fixed and is discharged to a discharge tray 31. A recording medium may be placed on the recording media transporting belt 29 by manually inserting using manual inserting roller 28a.

As the image forming apparatus shown in FIG. 1 has the primary transfer part where the intermediate transfer belt 21 is horizontally disposed, a space occupied by the belt becomes large. Further accordingly, volumes of toner hoppers in each of which a different colored toner is stored need to be equalized so that it is necessary to frequently replenish a black toner that is consumed comparing to the number of times to replenish other toners.

An image forming apparatus to avoid such drawback has been disclosed for example in Japanese laid-open patent publication JP1996-87151. In the apparatus, a transporting pathway for recording media which are transported through a plurality of image forming units is inclined with respect to the horizontal direction.

Back to the former image forming apparatus having the aforementioned intermediate transfer belt, the driving roller 22a, the supporting roller 22b, the tension roller 23, the backup roller 24 and the primary transfer roller are fixed to an intermediate transfer belt supporting frame to compose an intermediate transfer belt unit. The tension roller 23 is disposed between the supporting roller 22b and backup roller 24. Since the tension roller 23 applies a tension toward the intermediate transfer belt 21, it presses the belt in the direction shown by the dashed arrowhead (line) in the figure. Hence, the intermediate transfer belt is inflated in the direction of the dashed arrowhead (line).

As mentioned above, in the image forming apparatus shown in FIG. 1, because the intermediate transfer belt 21 is horizontally disposed in the primary transfer part and the backup roller 24 is disposed under the primary transfer part and between the driving roller 22a and the supporting roller 22b, it is inevitable that the intermediate transfer belt unit lengthens in the left and right direction in the figure, which results in a large size of the intermediate transfer belt unit.

Since the fixing device 30 is disposed in the down stream of and under the intermediate transfer belt unit and the recording media transporting belt 29 moves between the secondary transfer roller 25 and the backup roller 24, if the intermediate transfer unit becomes large in size, in other words, if the intermediate transfer belt exists, the image forming apparatus itself becomes large in size.

That is to say the image forming apparatus shown in FIG. 1 needs to have a larger image forming apparatus casing 32 as the intermediate transfer belt unit becomes larger in size. As a result, a useless dead space in the casing increases.

Further, as the intermediate transfer belt needs at least four rollers (i.e. the driving roller 23a, the supporting roller 23b, the tension roller 23 and the backup roller 24, in addition the primary transfer roller needs to be provided), the apparatus inevitably becomes heavy.

Apart from that, as mentioned before, since the backup roller 24 is disposed under the primary transfer part and between the driving roller 22a and the supporting roller 22b while the tension roller 23 is disposed between the supporting roller 22b and the backup roller 24, an angle between the intermediate transfer belt 21 and the recording media transporting belt 29 is small so that it is difficult to separate the recording media from the intermediate transfer belt. That is to say, on account of the poor separativeness of recording media, a media separating mechanism (unshown) needs to be provided in addition.

Thus, no consideration is taken concerning the compact design of and the good separativeness of recording media of the image forming apparatus shown in FIG. 1. Meanwhile, Japanese laid-open patent publication JP 1996-87151 discloses an image forming apparatus without an intermediate transfer belt. Accordingly, the apparatus does not have such advantages of an image forming apparatus with an intermediate transfer belt such as images without color drift can be obtained or kinds of media (thin paper, thick paper, transparent material or label paper) can be used without restriction. Further, in case of direct transfer, there is such designing limitation that a fixing device needs to be on the same line as a transporting pathway for recording media.

As stated previously, the driving roller 23a, the supporting roller 23b, the tension roller 23, backup roller 24 and the primary transfer roller are supported on the supporting frame to compose the intermediate transfer belt unit with which the endless intermediate transfer belt is supported. The endless belt also transports recoding medium.

The intermediate transfer belt can not be mounted to the intermediate transfer belt unit, unless the outer circumference of the surface of the intermediate transfer belt unit which contacts the intermediate transfer belt is smaller than the inner circumference of the intermediate transfer belt. Besides, when mounting, it needs close attention so as not to damage the surface of the intermediate transfer belt and workers have a big burden.

A big difference in dimension between the outer circumference of the surface of the intermediate transfer belt unit which contacts the intermediate transfer belt and the inner circumference of the intermediate transfer belt needs to be provided for this reason while an appropriate tension needs to be applied to the intermediate transfer belt. Thus, the tension roller is necessary to remove a distortion in case of the large dimensional difference. However, if the tension roller is provided, a mounting space and a mechanism for applying tension are necessary so that a useless space is generated as well as a structure becomes complicated, which leads to increasing number of component members, increasing in weight and finally going up in cost for the apparatus.

The intermediate transfer belt unit has a protective cover mounted in the unit for protecting edges of the intermediate transfer belt. The protective cover is as a matter of course mounted after the intermediate transfer belt is mounted. Accordingly, when the intermediate transfer belt is replaced for maintenance or recycling the belt unit, the protective cover is inevitably removed in advance. Thus generated such futile step lessens ease of maintenance.

To overcome such drawback, Japanese laid-open patent publication JP1996-123294 discloses an image forming apparatus having a cartridge of an intermediate transfer belt, the cartridge provided with a supporting member for changing a belt, wherein a tension roller of the intermediate transfer belt is made to be movable against a spring so as to support the intermediate transfer belt by letting the tension roller move toward a driving roller when changing the intermediate transfer belt. Thus, the intermediate transfer belt of the apparatus is changeable as a whole cartridge having the supporting member for changing a belt is changed.

Another conventional apparatus is disclosed in Japanese patent publication JP3175631. The image forming apparatus has a secondary transfer device under and opposite side of a fixing device from the center of the longitudinal direction of an intermediate transfer belt so as to provide an enough distance between the secondary transfer device and the fixing device and further has a roller for restricting meandering of the belt so as to keep an appropriate tension of the intermediate transfer belt.

However, the apparatus disclosed in Japanese laid-open patent publication JP1996-123294 needs to change a whole cartridge having the supporting member when changing the belt and has a complicated structure. The supporting member for changing a belt is also discarded together with the belt, and it is considered to bring about drawbacks economically and environmentally.

The apparatus disclosed in Japanese patent publication JP3175631 has an additional roller for restricting meandering of the belt, which enlarges a running region for the intermediate transfer belt so that it is difficult to design a compact apparatus, leading the cost of the apparatus higher. Besides, when changing the endless intermediate transfer belt, a cleaning device which cleans paper powder, waste toner or others remaining on the endless belt needs to be replaced.

Further, an ultimate elongation of the belt in the periphery direction needs to be minimum. Consequently, an appropriate thickness of the intermediate transfer belt is required, which necessitates hardness of the belt itself. The resultant stiff belt brings about image defects such as an image without midsection. If a rate difference is given between that of an image bearing body and the intermediate transfer body, apparent malfunction of transportation of the belt or color drift occurs. Although an attempt to minimize an ultimate elongation of the belt using material having a high tensile strength such as polyimid resin is done, the material is expensive and hard in its property so that a large nip is necessary when transferring and a high powered motor is necessary to drive accurately.

Japanese laid-open patent publication JP1998-240024 describes an intermediate transfer belt wherein a fibrous substrate is accompanied in rubber to minimize an ultimate elongation of the belt and further a releasing layer is provided on the surface. Though the belt makes a certain level of progress in a point of elongation, soft rubber material is scraped by friction with the driving roller to affect driving performance and the belt expands by running for a long time to bring about color drift.

### SUMMARY OF THE INVENTION

An object of the present invention is to provide a compact image forming apparatus having an intermediate transfer belt which is compact and has a good property of separating recording medium.

Another object of the present invention is to provide an image forming apparatus capable of easily mounting for changing an endless intermediate transfer belt to a belt unit.

Yet another object of the invention is to provide an image forming apparatus having a cleaning device capable of easily being put on and taken off when changing the endless intermediate transfer belt.

Yet another object of the invention is to provide an image forming apparatus capable of obtaining a stable quality of images for a long time without generating elongation or crack of the intermediate transfer belt.

According to the present invention, an image forming apparatus having a plurality of image forming units and each of which forms a toner image by developing an electrostatic latent image on an image bearing body provided in correspondence to each color, an intermediate transfer body which is transported along a predetermined transport pathway and to which the toner image is transferred in a primary transfer part as a primary transfer image, the image forming units are disposed along the primary transfer part, and in which an image is formed by secondarily transferring the primary transfer image to a recording medium with a secondary transfer roller at a position of a secondary transfer position disposed at downstream side of the primary transfer part, a transporting pathway of the primary transfer part is inclined upwardly in the direction from an image forming unit disposed at the most upstream point to an image forming unit disposed at the most downstream point. The primary transfer part has a first roller which transports the intermediate transfer body, a second roller which gives a tension to the intermediate transfer body and a third roller which confronts the second roller at secondary transfer position. An intermediate transfer body unit comprises the intermediate transfer body, the first roller, the second roller and the third roller where the primary transfer part is defined between the first roller and the second roller.

The intermediate transfer body unit also has a pressing member which presses the second roller toward the outward in the radius direction.

In this way, the image forming apparatus itself not only becomes compact but also a tension roller is unnecessary so that the weight of the intermediate belt unit can be reduced.

In this case, it is preferable to dispose the third roller vertically under the image forming unit disposed at the most upstream point.

In this way, a pressure of a spring of the primary transfer roller dose not affect secondary transfer to give an excellent image and a recording medium is easily separated from the intermediate transfer belt owing to an resultant large angle between the intermediate transfer belt and the recording media transporting belt.

For example, each of the image forming units is for yellow, magenta, cyan or black. The image-forming unit disposed at the most upstream point is for black.

As stated above, when a transporting pathway of the primary transfer part is inclined upwardly in the direction from an image forming unit disposed at the most upstream point to an image forming unit disposed at the most downstream point and the image-forming unit disposed at the most upstream point is for black, a good result of transfer is obtained because black toner has a lower melting point than other toners and black toner which is consumed frequently can be stored plentifully.

According to another aspect of the invention, an image forming apparatus has an endless belt and a supporting frame wherein the belt supporting frame is separable into a plurality of units in the orthogonal direction to the transporting direction of the endless belt and each unit is connected and supported so that a connected part is capable of bending in the bending direction of the endless belt. In this way, when mounting or replacing the endless belt to the belt supporting frame, such relation as the outer circumference of the belt contacting surface of the belt supporting frame is smaller than the inner circumference of the belt can be easily obtained. Hence, an image forming apparatus having a low cost frame capable of easily and simply mounting and replacing without damaging the surface of the belt, without increasing cost of adding a structure for changing the belt and without increasing workers' burden can be provided. Since each work for mounting is possible in the separate state, a productivity rate on the assembly line is improved and a turn-around time is shortened.

As a supporting point of bending of the supporting frame is provided at a valley side, the connected part can be bent in such direction as to decrease the outer circumference of the belt contacting surface of the belt supporting frame. Thus, the belt can be easily mounted or removed without damaging the surface of the belt and without separating the belt supporting frame into unit bodies. Consequently, an image forming apparatus having a low cost belt supporting frame can be provided.

Each unit body of the belt supporting frame has a vertical plane on the belt side of the supporting point of bending of the supporting frame. A mutual position between the units is restricted by contacting the planes so as to accurately restrict the position when the bent unit bodies are restored to the original state and to accurately mount the endless belt to the belt supporting frame.

Further, as for the supporting point for bending, a receiving part of the supporting point for bending the unit body has a round part of supporting face when turning the supporting point and a groove part for embedding the supporting point. The supporting point has a round part of approximately the same curvature as the receiving part and a flat part which is embedded to the groove part so that the supporting point which deviates from the groove part turns in the round part of the receiving part of the supporting point. Thus, when the unit bodies are positioned for connecting, the supporting point is easily embedded for the receiving part since the supporting point has the groove part in the innermost of the wide round part. And even though the unit bodies are bent, a turning supporting point turns smoothly without clattering in the round part which is a supporting face of the receiving part of the supporting point. Despite of the separable unit bodies, when the endless belt is mounted, the unit bodies can be bent as they are connected so that the endless belt can be mounted to the supporting frame even in the state that a guard member is attached to protect an edge part of the endless belt.

When the unit bodies are bent, a bending angle of the unit bodies is slightly smaller than an angle at which the supporting point departs from the round part of the receiving part of the supporting point whereby the belt is easily mounted or replaced without separating the unit bodies.

In order to mount the belt to the supporting frame, the belt supporting frame may be capable of separating into a plurality of units in the orthogonal direction to the transporting direction of the endless belt and each unit may be connected so that a connected part is capable of expanding and contracting in the straining direction of the endless belt.

In this way, a relation that the outer circumference of the belt-contacting-surface of the belt supporting frame is smaller than the inner circumference of the belt can be easily obtained without bending the unit bodies whereby an image forming apparatus having a low cost frame capable of easily and simply mounting and replacing without damaging the surface of the belt, without increasing cost of adding a structure for changing the belt and without increasing workers' burden can be provided.

In case each unit is connected so that a connected part is capable of expanding and contracting in the straining direction of the endless belt, a protruded part is provided on one of the unit body of the belt supporting frame which contacts to the other unit body each other and a recessed part to which the protruded part is embedded is provided on the other unit body while a member for latching is provided on the opening side of the recessed part, the protruded part is embedded in the recessed part when the endless belt is contracted in the straining direction of the belt and the protruded part is drawn from the recessed part while latching the other protruded part by the member for latching whereby the belt supporting frame is capable of expanding and contracting.

In this manner, the dimension of the outer circumference of the belt-contacting-surface of the belt supporting frame becomes smaller than the inner circumference of the belt without bending the unit bodies whereby an image forming apparatus having a low cost frame capable of easily and simply mounting and replacing without damaging the surface of the belt, without increasing cost of adding a structure for changing the blet and without increasing workers' burden canbe provided.

The endless belt constructed in this way is used for primarily transferring thereto an image formed on a photosensitive body and is also used for secondarily transferring the image to a final transferring member after that whereby the intermediate transfer belt is easily mounted and replaced otherwise it is hard to mount the belt to the frame and the belt is susceptible to surface damage because an expand in the circumferential direction is restricted.

When the supporting frame of the endless belt is applied to a supporting frame of an intermediate transfer belt, the belt supporting frame can be bent at the vicinity of the center so as to be able to bend where a total outer circumference of the supporting frame is the most shorter than the inner circumference of the endless belt whereby an image forming apparatus having a low cost frame capable of easily and simply mounting and replacing without damaging the surface of the belt, without increasing cost of adding a structure for changing the belt and without increasing workers' burden can be provided.

When the supporting frame of the endless belt is applied to a supporting frame of an intermediate transfer belt, images can be transferred with uniform pressure at the place without strain and diagonal traveling where the tension is largest by disposing the first primary transfer roller which primarily transfer the images at the position just after the downstream of the supporting roller which gives tension to the belt by pressing with a spring.

Further when the supporting frame of the endless belt is applied to a supporting frame of an intermediate transfer belt, the intermediate transfer belt is hard to be affected by heat generated from a fixing device on account of a cleaning mechanism by disposing the cleaning device which cleans wasted toner on the intermediate transfer belt at the position to be a heat insulating wall for the intermediate transfer belt against heat from the fixing device so that a distance between the fixing device and the secondary transfer roller can be decreased whereby a more compact image forming apparatus can be provided.

In addition, a belt supporting unit is composed by providing a supporting part having a higher supporting point than the surface of the endless belt at both lateral sides in the transporting direction of the endless belt, which protect the edge of the endless belt wherein a area defined by outer peripheral line of the belt supporting unit which is projected from the lateral side of the supporting part at the bent state is smaller than a area formed by the circumference of the endless belt so as to be able to mount or detach the endless belt.

As a area defined by outer peripheral line of the belt supporting unit which is projected from the lateral side of the supporting part at the bent state is smaller than a area formed by the circumference of the endless belt, even though the belt is tight set in such a manner that tension is generated between the driving roller and the tension roller by bending the belt supporting units, a distance of the belt supporting unit between the driving roller and the tension roller becomes short at the bent state so that the belt supporting unit is easily inserted into an elliptical or triangular opening even if there is the supporting part.

The endless belt is also easily mounted or replaced not only by inserting the supporting unit into the opening but also by making one of the supporting parts go through into the lateral opening of the endless belt in such a state that the belt supporting unit is bent as the supporting part is provided.

Further according to another effective embodiment of the present invention, an image forming apparatus comprises a roller supporting member which support a tension roller provided at a supporting part, each supporting member and supporting part at a position of confronting each other having a catching female part and a male part capable of catching and fixing a position of the supporting member utilizing a travel restricting width in the tension direction of the tension roller wherein the catching female part and the male part catch and fix at a region of traveling in the tension direction of the tension roller. According to the embodiment, the apparatus comprises a roller supporting member which supports the tension roller at a position confronting the roller supporting member of a supporting part protecting the edge of the endless belt having a supporting point higher than the surface of the endless belt when the endless belt is mounted at both lateral sides of transporting direction of the endless belt in the supporting part.

Each supporting member and supporting part at a position of confronting each other is provided a catching female part and a male part capable of catching and fixing a position of the supporting member utilizing a travel restricting width in the tension direction of the tension roller wherein the catching female part and the male part catch and fix at a region of traveling in the tension direction of the tension roller whereby the roller supporting member is easily mounted to the supporting part.

The roller supporting part is applied with a tension so that the roller supporting member can be kept being held to the supporting part by the female member's catching the male member. More specifically, it becomes possible to keep a state where the roller supporting member is mounted to the supporting part while applying a tension to the roller supporting part.

By the endless belt is tight set to the tension roller of the supporting member, unification of the units which are component parts of the belt supporting unit is possible without a connecting member with an added tension to the roller supporting member to cut a connecting member for reducing the cost.

According to yet another aspect of the invention, the image forming apparatus comprises a cleaning mechanism having a cleaning member which cleans paper powder or toner pressed and remaining on the surface of the circumference of the endless belt wherein a rotational shaft part of the cleaning mechanism is detachably and rotatably attached to the supporting frame and a frame of the cleaning mechanism is turned with the rotation of the rotational shaft part so that the frame of the cleaning mechanism faces the belt supporting frame, fixing the both frames at a point where the cleaning member presses the surface of the circumference of the endless belt.

Thus, since the cleaning mechanism has the rotational shaft part which is detachably and rotatably attached to the supporting frame, it is possible to be attached and detached to and from the belt supporting frame without screws or others.

As the rotational shaft part of the cleaning mechanism is detachably and rotatably attached to the supporting frame and the frame of the cleaning mechanism is turned with the rotation of the rotational shaft part so that the frame of the cleaning mechanism faces the belt supporting frame, fixing the both frames at the point where the cleaning member presses the surface of the circumference of the endless belt, a first action by which the rotational shaft part of the cleaning mechanism is attached to the belt supporting frame and a second action by which the cleaning frame is turned by a predetermined angle enable the cleaning member to be easily mounted to the position of the supporting frame where the belt supporting frame presses the surface of the circumference of the endless belt.

According to another effective embodiment of the present invention, a cleaning frame is capable of turning parallel in the vicinity of or in contact with a wall of the belt supporting frame while a catching member is provided on one frame face of the both frames, the catching member being capable of deforming elastically and catching holes provided on the other frame at a position corresponding to the position of pressing the endless belt of the cleaning member.

According to the embodiment, the cleaning frame is capable of turning parallel in contact with or otherwise in the vicinity of a wall of the belt supporting frame. A catching member capable of deforming elastically is provided on one frame face of the both frames and further holes are provided on the other frame. The catching member capable of deforming elastically catches the holes provided on the other frame at a position corresponding to the position of pressing the endless belt of the cleaning member. Thus, the cleaning member is easily mounted to a position of the belt frame where the cleaning frame is pressed to the surface of the circumference of the endless belt.

It is preferable that the holes which catch rotatably the rotational shaft part of the cleaning mechanism, i.e. the holes which catch detachably and rotatably the rotational shaft part of the cleaning mechanism to the belt supporting frame, are provided as a circular hole and an arc opening, the arc having less than half circle and are positioned so that a supporting face of the arc opening is opposed to a circumference surface pressing direction of the endless belt of the cleaning member.

In this way, as the catching holes which catch the rotational shaft part of the cleaning mechanism are formed as a circular hole and a arc hole, the arc having less than half circle, when a half circular holding opening is provided on one side of the frames of the belt supporting unit lateral face and a circular holding opening is provided on the other side of the frames, the other end of the rotational shaft part can be inserted to the circular holding opening on the other side of the frames and one end of the rotational shaft is inserted to the half circular holding opening on the one side of the frames from an opening side of the half circle so that it is unnecessary to be provided a pair of holding openings having elastic members for widening the openings to insert.

It is preferable that the rotational shaft part of the circular hole side is constructed in such a manner that it is capable of connecting a driving system which drives a screw provided in the cleaning mechanism to discharge residual toner. In this way, a driving force is easily and reliably communicated to the screw by connecting the driving system which drives the screw discharging residual toner coaxially with the rotational shaft part.

According to yet another effective embodiment of the present invention, an elastic force imparting device is provided to a shutter mechanism which opens and closes a discharge opening of waste toner on a side of a cleaning frame of the cleaning mechanism so as to keep an opening state of the shutter mechanism by pressing the elastic force imparting device to impart an elastic force with the apparatus itself or one of members that the apparatus itself has. In this regard, it is preferable that an opening position of the shutter is set by pressing the elastic force imparting device to impart an elastic force with the apparatus itself or one of members that the apparatus itself has and a closing of the shutter is possible to close the shutter by departing the apparatus itself or one of members that the apparatus itself has from the belt supporting unit while an elastic force imparted through the elastic force imparting device of the cleaning member is cancelled by closing the shutter.

According to the embodiment, an inner part of the apparatus is not contaminated with scattered toner since the shutter mechanism with the elastic force imparting device to open and close the discharge opening for waste toner is provided on the cleaning frame and an opening state of the shutter mechanism can be maintained by pressing the elastic force imparting device with the apparatus itself or one of members that the apparatus has by mounting the belt supporting unit at the mounting position of the apparatus itself when the belt supporting unit having the cleaning mechanism is mounted to and detached from the apparatus itself side and the discharge opening for waste toner can be closed by canceling the pressure of the apparatus itself or one of the members that the apparatus itself has when the belt unit is dismounted.

According to yet another aspect of the invention, an image forming apparatus comprises an image bearing body which forms an image by an electro-photographic method, an intermediate transfer belt which is rotated by a driving roller and transfers primarily the image on the image bearing body and a mechanism for secondarily transferring the image on the intermediate transfer belt to a final transfer member wherein the intermediate transfer belt has a plurality of layers of two layers or more, and when a percentage difference of a stretched length of an outer circumference of the intermediate transfer belt to an inner circumference thereof at a position of contact to the driving roller is A % and a percent difference of a length of stretched side of the belt driven and stretched by the driving roller to a length of non-stretched opposite side of the belt is B %, a relation 3<A<7 and 3<A+B<10 are obtained.

In this way, even if a small diameter driven roller of a large curvature is used for driving the intermediate transfer belt, as a percentage difference of a stretched length of an outer circumference of the intermediate transfer belt to an inner circumference thereof at a position of contact to the driving roller “A” falls into the inequality 3<A<7, the intermediate transfer belt can bear elongation which absorb a distortion at a maximum curvature of the driving roller so as to keep durability and prevent color drift and an image without midsection when transferring.

Since a percent difference of a length of stretched side of the belt driven and stretched by the driving roller to a length of non-stretched opposite side of the belt “B” falls into the inequality 3<A+B<10, an impact by the driving roller when driving is absorbed by a small elongation of the intermediate transfer belt so as to prevent dilatation and crack. As a result, a compact image forming apparatus having an intermediate transfer belt which gives a stable image quality for a long time without color drift.

A base material layer of the intermediate transfer belt is made so that the base material layer has a thickness of 50 μm or more and 150 μm or less and a percent difference of a length of the base material layer of stretched side of the belt driven and stretched by the driving roller to a length of the base material layer of non-stretched opposite side of the belt is 1-10%.

By thus making the base material layer of the intermediate transfer belt, the belt can keep such strength that a rotational energy from the driving roller is accurately transmitted to the whole intermediate transfer belt. Also, it is possible to offer a compact forming apparatus having an intermediate transfer belt which give a stable image quality for a long time without color drift since a percent difference of a length of streched side of the belt driven and stretched by the driving roller to a length of non-stretched opposite side of the belt “B” falls into the inequality 3<A+B<10.

Further, an elastic material layer which compose the intermediate transfer belt is made so that the thickness of the elastic material layer is 300 μm or more and 700 μm or less and a percent difference of a length of the elastic material layer of stretched side of the belt driven and stretched by the driving roller to a length of the elastic material layer of non-stretched opposite side of the belt is 2-10%.

A thickness and elongation of the elastic material layer of the intermediate transfer belt are particularly important to control formation of a transfer nip, color drift or an image without midsection. With such thickness and elongation, the transfer nip can be taken with the image bearing body so that stable transportation is possible as an intermediate transfer belt. As a result, a compact image forming apparatus having an intermediate transfer belt which enable a quality stable image can be provided.

It is preferable for a surface layer of the intermediate transfer belt to contain fluorocarbon resin. Thus, because an outermost surface comprises a releasing material layer, images can be transmitted to the surface of the image bearing body without damaging resilience of the underlain elastic material layer so as to be able to obtain enough transferring and releasing effect and stable durability. As a result, a compact image forming apparatus having an intermediate transfer belt which enable a quality stable image can be provided.

Further, it is preferable that the driving roller is made of metal and has a diameter of 25 mm or less, the surface of which is treated with ceramic particles which do not perform plastic deformation to obtain a surface roughness of Rz=1-15 μm.

With thus composed driving roller, stable driving of the intermediate transfer belt can be materialized without giving the intermediate transfer belt a big distortion, without jumboizing the apparatus itself and further without generating a drawback of leaving concavity and convexity on the surface of the intermediate transfer belt which communicate the driving force.

### BRIEF DESCRIPTION OF THE DRAWINGS

FIG. 1 is a schematic drawing showing a conventional image forming apparatus.

FIG. 2 is a schematic drawing showing one embodiment of an image forming apparatus according to the present invention.

FIG. 3 is a view showing a frame format of a substantial part of the image forming apparatus shown in FIG. 2.

FIG. 4 is a partly fractured sectional drawing of the intermediate transfer belt unit shown in FIG. 3.

FIG. 5 is a perspective drawing illustrating one embodiment of a belt supporting frame according to the present invention.

FIG. 6 is a perspective drawing illustrating mounting an endless belt according to the present invention.

FIG. 7 is a schematic drawing illustrating a case of a belt supporting frame applied to a supporting frame of the intermediate transfer belt according to the present invention.

FIG. 8 is an enlarged illustration showing a supporting part of the belt supporting frame shown in FIGS. 9(A) and (B) are illustrative drawings showing a bending state of the belt supporting frame according to the present invention.

FIGS. 10(A) and (B) are schematic drawings illustrating another embodiment of an expanding and contracting structure of the belt supporting frame according to the present invention.

FIG. 11 is a schematic drawing illustrating another embodiment of the belt supporting frame applied to a supporting frame of the intermediate transfer belt according to the present invention.

FIG. 12 is a perspective drawing illustrating a procedure of mounting a cleaning device to the supporting frame of the intermediate transfer belt.

FIGS. 13(A) and (B) are schematic drawing illustrating a procedure of mounting a cleaning device to the supporting frame of the intermediate transfer belt.

FIGS. 14(A) and (B) are schematic drawing illustrating a procedure of mounting a cleaning device to the supporting frame of the intermediate transfer belt.

FIG. 15 is a perspective drawing illustrating a procedure of mounting the cleaning device to the supporting frame of the intermediate transfer belt.

FIG. 16 is a schematic drawing illustrating a procedure of detaching an intermediate transfer unit.

FIG. 17 is a schematic drawing illustrating a procedure of detaching an intermediate transfer unit.

FIGS. 18(A) and (B) are schematic drawings illustrating a structure around the intermediate transfer belt of the image forming apparatus.

FIG. 19 is a schematic drawing showing one embodiment of a structure of a part of an intermediate transfer belt according to the present invention.

FIG. 20 is a table showing a result of evaluating variation of components of an intermediate transfer belt according to the present invention.

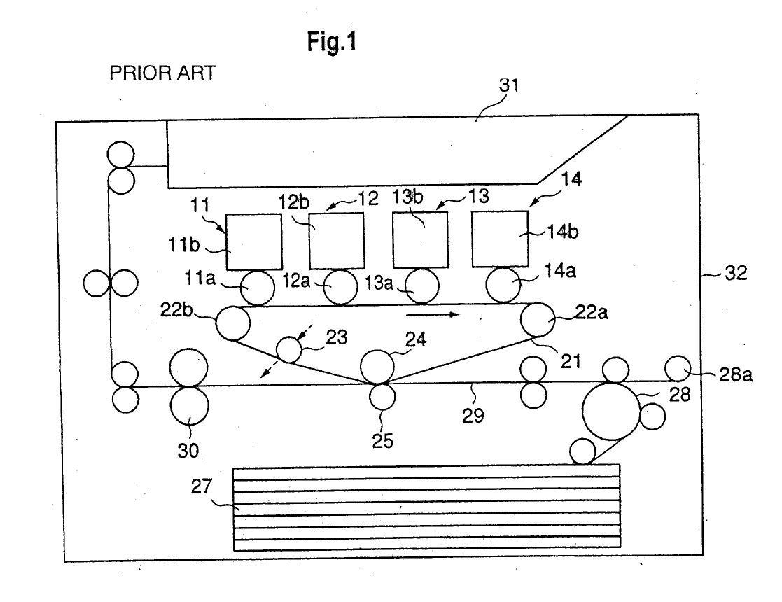

### DETAILED DESCRIPTION OF THE PREFERRED EMBODIMENT

The invention will now be described below in detail by way of example with reference to the accompanying drawings. It should be understood, however, that the description herein of specific embodiments such as to the dimensions, the kinds of material, the configurations and the relative disposals of the elemental parts and the like is not intended to limit the invention to the particular forms disclosed but the intention is to disclose for the sake of example unless otherwise specifically described.

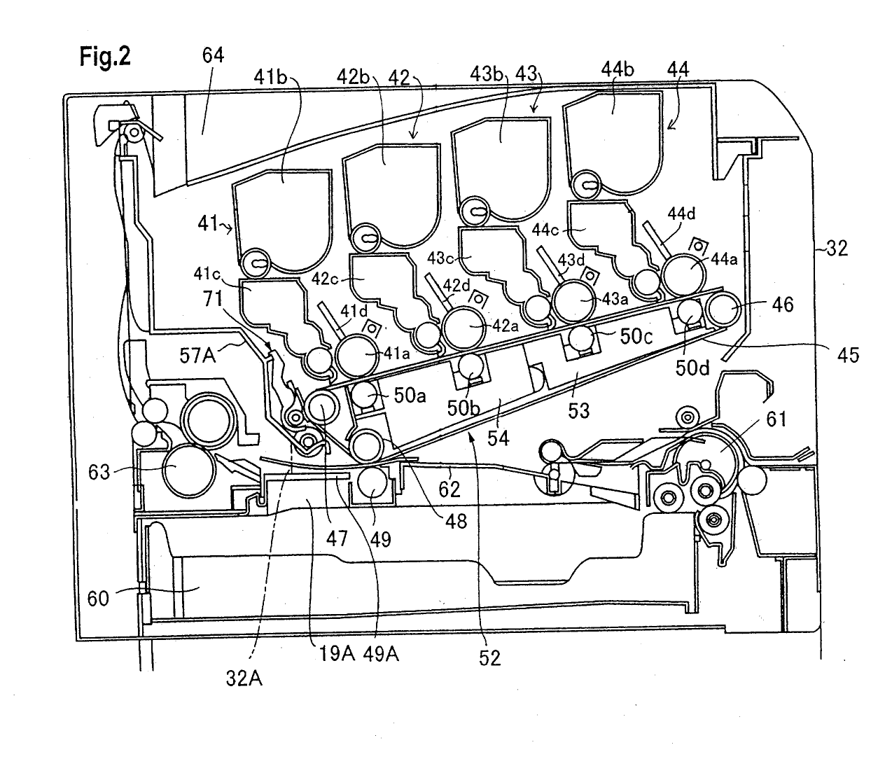

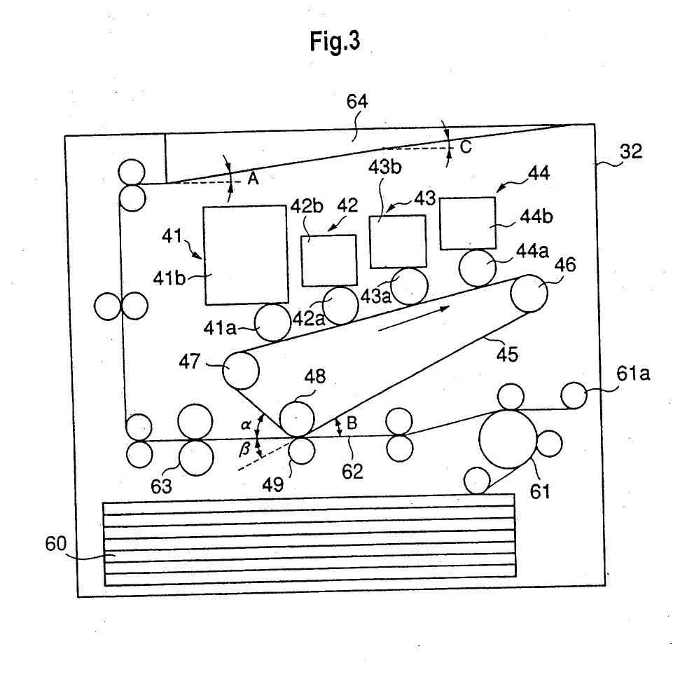

Referring to FIGS. 2 and 3, the image forming apparatus shown in the figures has a plurality of image forming units 41-44. Each of the units 41-44 is provided with each of photosensitive body drums (image bearing bodies) 41a-44a, each of developing devices 41c-44c (not shown in FIG. 3) and each of exposing units 41d-44d (not shown in FIG. 3). Each of the image forming units 41-44 has each of toner containers 41b-44b. Each of the image forming units has a handle (not shown in the figure) by turning which by a predetermined angle, the photosensitive body drum leaves an intermediate transfer belt 45 while latch is cancelled to be able to draw and take out the image forming unit.

As shown in the figure, each of the image forming units 41, 42, 43, or 44 corresponds to black, yellow, magenta, or cyan respectively. These image forming units 41-44, i.e. the photosensitive body drums 41a-44a are disposed along a transporting direction of the intermediate transfer belt 45. Then the photosensitive body drum 41a is disposed at the most upstream point and the photosensitive body 44a is disposed at the most downstream point.

The intermediate transfer belt 45 is supported by a driving roller (a first roller) 46, a supporting roller (a second roller) 47 and a backup roller (a third roller) 48, is driven by the driving roller 46 in the direction shown by a solid arrow headed line and is tensed, as is described later, with a predetermined tension by the supporting roller 47.

The backup roller 48 is disposed so as to face a secondary transfer roller 49. A primary transfer part is defined between the driving roller 46 and supporting roller 47. The aforementioned image forming units 41, 42, 43 and 44 are disposed along the primary transfer part.

As shown in FIG. 2, a cleaning device 71 is provided for cleaning residual toner (waste toner) on the intermediate transfer belt 45. A heat insulating wall 57A is provided on the left side of the cleaning device 71 in order to intercept a heat generated from a fixing device 63 from the intermediate transfer belt 45, a belt supporting frame 51 and a developing device. The cleaning device 71 is disposed in contact with the heat insulating wall 57A so as not to be affected by the heat of the fixing device 63 and so as to shorten the distance between the fixing device and the secondary transfer roller or the intermediate transfer belt in order to construct a more compact image forming apparatus.

A waste toner container 19A is disposed under the cleaning device 71 through a waste toner wall 49 which has a waste toner piping 32A which extends to the part under an unshown waste toner discharging port of the cleaning device 71.

As shown in the figure, the intermediate transfer belt 45 is slanted from the left to the right of the figure at the primary transfer part. That is, the intermediate transfer belt 45 is upwardly slanted toward the direction of the photosensitive body drum 44a from the photosensitive body drum 41a. The backup roller 48 is disposed vertically under the primary transfer roller (not shown in FIG. 3), i.e. the backup roller 48 is disposed vertically under the photosensitive body drum 41a. Consequently, the backup roller 48 is disposed at close hand to the driving roller 46.

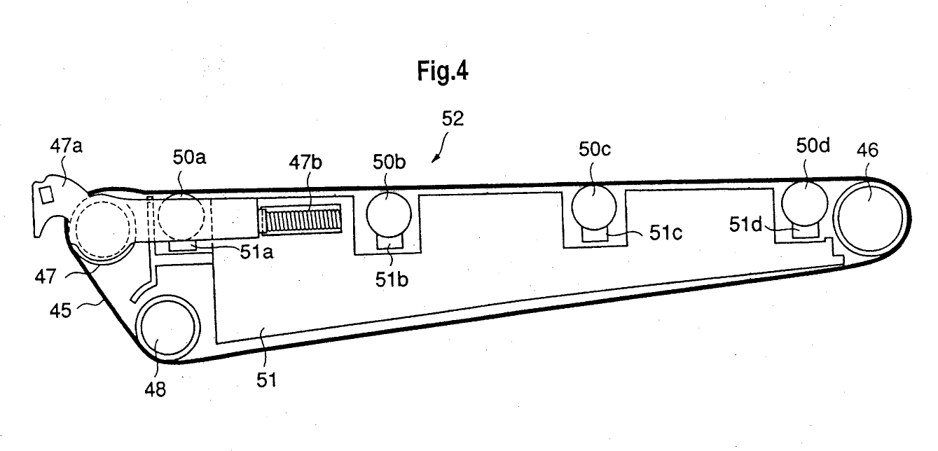

Now referring to FIG. 4 together, the aforementioned driving roller 46, supporting roller 47, backup roller 48 and primary transfer roller 50a-50d is held on the supporting frame 51 to become an intermediate transfer belt unit 52.

The intermediate transfer unit 52 has a supporting roller holding member 47a which holds the supporting roller 47 and is movable toward the traveling direction of the intermediate transfer belt on the belt supporting frame 51. The supporting roller holding member 47a is pressed by a spring (pressing member) 47b so that the supporting roller 47 applies tension to the intermediate transfer belt 45 to tense the intermediate transfer belt 45. The primary transfer rollers 50a-50d are pressed to the direction of the photosensitive body rollers 41a-44a by springs 51a-51d.

Referring to FIG. 3 and FIG. 4, when an image is formed on a recoding medium, a toner image is formed on the photosensitive body drums 41a-44a synchronized with moving of the intermediate transfer belt. The toner image is sequentially transferred primarily on the intermediate transfer belt 45 to form a primary transfer image. The recording medium is transported by a paper reversing roller 61 from a paper supplying unit 60 on a recording medium transporting belt 62 to a secondary transfer position. The recording medium is sandwiched between the backup roller 48 and the secondary transfer roller 49 together with the intermediate transfer belt 45 and the toner image is transferred secondarily onto the recording medium by the secondary transfer roller 49. After that, the recording medium is sent to the fixing device 63 where the image is fixed and discharged to a discharge tray 64. A recording medium may be inserted on the recording medium transporting belt 62 by manual insertion using a roller for manual insertion 61a.

Since the image forming apparatus shown in FIG. 3 has a supporting roller 47 that applies tension to the intermediate transfer belt, an additional tension roller is not necessary. Besides, since a primary transfer is made by the first primary transfer roller 50a just after having applied tension, the intermediate transfer belt is hard to distort so that stretching of the intermediate transfer belt 45 is uniform.

Since, as shown in FIG. 4, the backup roller 48 is disposed vertically under the first primary transfer roller 50a, an elastic force imparted by the spring 51a affects only in the vertical direction to the backup roller 48. As a result, an elastic force imparted by the spring 51a at the secondary transfer is hard to be affected.

Since, as mentioned before, the intermediate transfer belt 45 is acclivitous in the direction of the photosensitive body drum 44a from the photosensitive body drum 41a at the primary transfer side so that the secondary transfer position is vertically under the photosensitive body drum 41a (i.e. the primary transfer roller 50a), the left upper part of the FIG. 3 becomes spacious so that a big toner container 41b can be disposed in the image forming unit 41.

Letting the image forming unit 41 of the most upper stream side be for black (K), as black (K) toner has a lower melting point than the other colors, good transfer can be obtained and black toner which is frequently consumed can be stored plentifully. As the intermediate transfer belt 45 is slantwise disposed, the transporting pathway to the fixing device 63 can be defined within a range of α+β, where α is an angle between the intermediate transfer belt at the part between the backup roller 48 and the supporting roller 47 and the paper transporting pathway, β is an angle between an extended line of the intermediate transfer belt at the part between the driving roller 46 and the backup roller 48 and the paper transporting pathway. Consequently, the fixing device, furthermore the image forming apparatus as a whole can be designed flexibly. Thus, a distance between the secondary transferring position and the fixing device 63 can be shortened so that the image forming apparatus as a whole can be reduced in size.

Further, because the backup roller 48 is disposed vertically under the first primary transfer roller 50a, i.e. because the supporting roller 47 is disposed close to backup roller 48, an angle between the intermediate transfer belt 45 and the recording media transporting belt 62 becomes large so that the recording medium can be easily separated from the intermediate transfer belt.

It is preferable that an angle of gradient of intermediate transfer belt is restricted so as to satisfy the equation (A+C)/2˜3=B or the inequality A>B+5°˜10°, where A is an angle of gradient of first half of an upper paper discharge part, B is an angle of gradient of the intermediate transfer belt 45 and C is an angle of last half of the upper paper discharge part.

It is found that when the angle of gradient of the intermediate transfer belt is restricted in this manner, the image forming units such as the photosensitive body drums and the toner containers can be disposed suitably in a space between an upper cover and the intermediate transfer unit. Furthermore, the right under space in the figure becomes spacious so that the paper reversing roller and the roller for manual insertion can be disposed in the space whereby the image forming apparatus as a whole can be reduced in size.

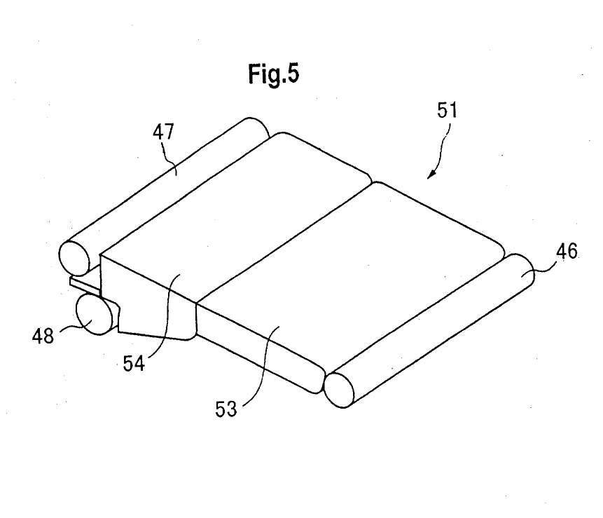

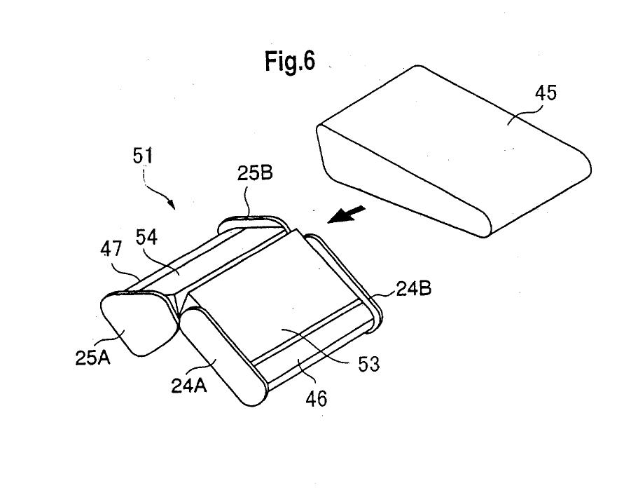

Now another embodiment of an intermediate transfer belt unit (hereinafter referred to as the belt unit) is explained as follows. AS shown in FIG. 5 and FIG. 6, an intermediate transfer belt supporting frame (hereinafter referred to as the belt supporting frame) 51 has a unit body 53 and 54 and, as mentioned before, the driving roller 46, the supporting roller 47 and the backup roller 48. Guide members (protective covers) 24A, 24B, 25A and 25B are provided at the lateral side of the belt supporting frame 51.

The unit body 53 and 54 of belt supporting frame 51 can be horizontally stretched shown in FIG. 5 and can be bent as shown in FIG. 6.

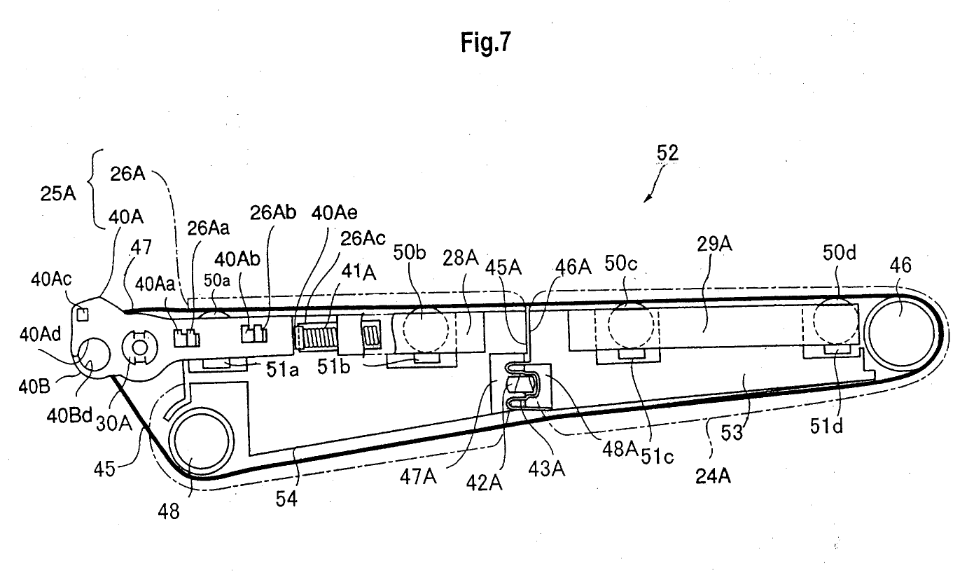

As shown in FIG. 7, the unit body 54 has the primary transfer roller 50a and 50b. The guide members 25A and 25B are attached on both lateral sides of the unit body as shown in FIG. 6. A holding member 40A for the supporting roller comprises a guide member 26A and 25A drawn in dashed line.

A holding member 40A for the supporting roller has a bearing 30A for the supporting roller 47, openings 40Aa, 40Ab, a hole 40Ac for positioning a cleaning device mentioned later, a half circular hole 40Ad, a contact part 40Ae. Protrusions 26Aa and 26Ab are provided on the lateral side of the guide member 26A which are inserted into the openings 40Aa, 40Ab of the holding member 40A for the supporting roller so as to contact the contact part 40Ae with the left end of a spring 41A disposed at a recessed part 26Ac whereby the holding member 40A for the supporting roller is pressed by the spring 41A through the contact part 40Ae to move toward left, the guide member 26A attached by holding pressure toward the left.

A protective cover 28A is attached to the guide member 26A by inserting protrusions (not shown) on the outer lateral side of the guide member 26A into the openings (not shown) of the protective cover 28A in the same manner as attaching the guide member 26A to the holding member 40A for the supporting roller.

A guide member 26B of the same size as the front one is disposed in the back of the drawing. An opening is provided on the lateral side of the guide member 26B where the spring 41A is disposed. A holding member 40B for the supporting roller and a protective cover 28A are disposed. The protective cover 28A can be used the same member as the front one. However, a whole circular hole is provided coaxially with a half circular opening 40Ad of the front side holding member 40A as an opening of the holding member 40B for the supporting roller.

Attaching the holding member 40B for the supporting roller and the protective cover 28A to the guide member 26B is the same as attaching the holding member 40A for the supporting roller and the protective cover 28A to the guide member 26A. The holding member 40B for the supporting roller can be attached to the guide member 26B by pressing with the spring through the contact part to move toward left.

The unit body 53 has the primary transfer rollers 50c and 50d on both sides of which the guide members 24A and 24B are attached as shown in FIG. 6. The protective cover 29A is attached to the guide member 24A by inserting unshown protrusions on the lateral side of the guide member 24A into unshown openings of the protective cover 29A likewise as the holding member for the supporting roller 40A is atttached to the guide member 26A. The guide member 24B having the same outside dimension as the front one is disposed to the back side of the drawing, the lateral side of the guide member 24B also having the protective cover 29A.

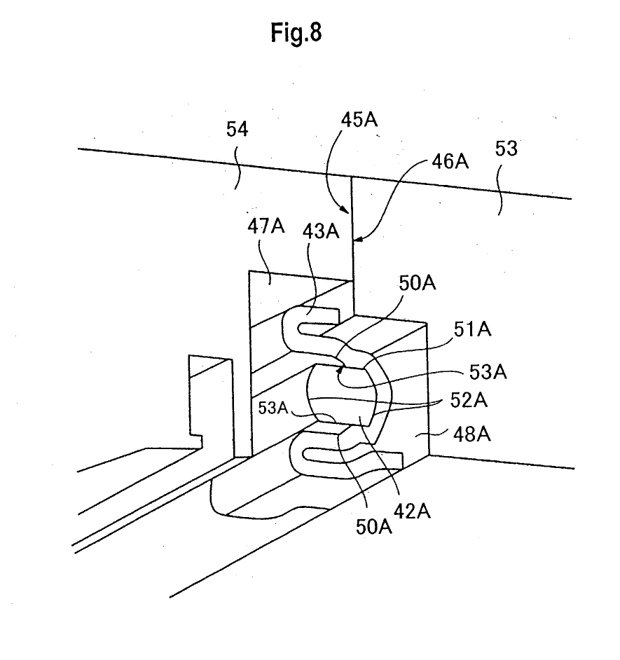

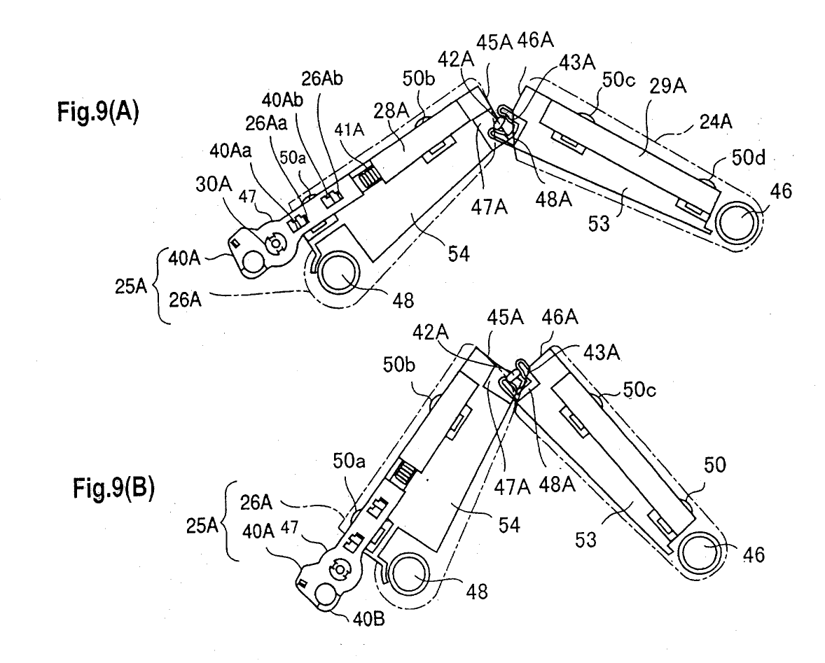

In FIG. 7, 42A is a supporting point for bending provided on the unit body 54. 43A is a recieving part of the supporting point for bending having a round part of supporting face when turning the suporting point 42A and a groove part for embeding the supporting point. 51a-51d are springs which press primary transfer rollers 50a-50d toward the photosensitive bodies. As shown in FIG. 8, the recieving part of the supporting point for bending 43A has the round part 50A of supporting face when turning the suporting point 42A and a groove part 51A for embeding the supporting point. The suporting point 42A comprises a round part 52A of approximately the same curvature as a round part 50A of the recieving part of the supporting point for bending 43A and a flat part 53A which is embedded to the groove part 51A. The supporting point 42A and the receiving part 43A are disposed to recessed part 47A and 48A provided on the unit bodies 53 and 54. Both sides of the longitudinal direction of the supporting point 42A are fixed to the holding member provided on the unshown unit boy 54.

Now, a method for mounting the intermediate transfer belt 45 to the belt supporting frame 52 is explained. As stated above, the belt supporting frame 52 is composed so as to be capable of separating into a plurality parts such as tow unit bodies 53 and 54 to the direction perpendicular to the transporting direction of the intermediate transfer belt.

The unit body 53 comprises a driving roller 46 which drives the intermediate transfer belt 45, primary rollers 50c, 50d, springs 51c, 51d which press primary transfer rollers 50a-50d so as to contact the intermediate transfer belt to photosensitive bodies, the receiving part 43A of the supporting point for bending which enables bending of the unit bodies 53, 54 by receiving the supporting point for bending 42A provided on the unit body 54.

The unit body 54 comprises a supporting roller 47, a backup roller 48, primary transfer rollers 50a, 50b, springs 51a, 51b which press primary transfer rollers 50a, 50b so as to contact the intermediate transfer belt 45 to photosensitive bodies, a holding member 40A for the supporting roller which is capable of moving to the running direction of the intermediate transfer belt and supports the supporting roller 47 and enables the intermediate transfer belt to stretch with tension, and a supporting point for bending 42A.

The belt unit 52 has the backup roller 48 for supporting the belt facing the secondary transfer roller (FIG. 3) at the ends of the guide member 26A and 26B so as to bend the belt frame 51 at the vicinity of its center whereby a whole outer circumference of the belt supporting frame 51 is shorter than an inner circumference of the intermediate transfer belt 45.

The first primary roller 50a which primarily transfers an image is disposed at right downstream position after the supporting roller whereby an image is transferred with a uniform pressure at the position where strong tension is generated but without strain and diagonal traveling.

As shown in FIG. 8, the receiving part 43A of the supporting point for bending has a round part 50A which becomes a supporting surface when the supporting point 42A is turned in the receiving part 43A and a groove part 51A into which the flat part 53A of the supporting point 42A is embedded; the supporting point 42A has a round part 52A which has the approximately same curvature as the round part 50A of the receiving part 43A has a flat part 53A which is embedded into the groove part 51A.

The unit bodies 53, 54 have vertical planes 45A, 46A at the belt side of the upper part of the supporting point 42A. When the flat part 53A of the supporting point 42A is embedded into the groove part of the receiving part 43A, the vertical planes contact each other. Thus, the unit bodies 53, 54 are unified firmly by strict positioning when the supporting point 42A is embedded into the groove part 51A of the receiving part 43A.

When the unit bodies 53, 54 are bent as shown in FIG. 9(A), the supporting point 42A which is at the valley side of bending comes off from the groove part 51A of the receiving part 43A to escape and then the round part 52A of the supporting point 42A is caught by the round part 50A of receiving part 43A to turn. Thus, the unit bodies 53, 54 can be bent smoothly without departing as turning by being caught at the round part 50A of the receiving part 43A. A bending angle of the unit bodies 53, 54 is an angle just before the angle by which the supporting point 42A comes off from the round part 50A of the receiving part 43A, i.e. an angle by which the supporting point comes off from the receiving part 43A if the unit bodies are bent more over as a bottom face of the unit 53 or a bottom face side of the receiving part 43A contacts a bottom side of the recessed part of the unit 53.

Hence, the unit bodies 53, 54 can be bent while they are connected though they are separable when the intermediate transfer belt is mounted. As shown in FIG. 9, by bending to the direction in which the whole circumference of the belt supporting frame 51 is shorter than the inner circumference of the intermediate transfer belt 42, the intermediate transfer belt 45 can be mounted to the supporting frame 51 even if the guide members 24A, 24B, 25A and 25B for protecting the edge of the intermediate transfer belt are attached.

Therefore, a cartridge having a supporting member for exchange, which is necessary for a conventional apparatus, is needless. It is unnecessary to fit the inner length of the belt with the supporting frame and tension roller by disposing the tension roller apart from the belt frame. As such complicated mechanism and designing a large sized image forming apparatus are unnecessary for the present invention, an image forming apparatus having a low cost frame capable of easily and simply mounting and replacing without damaging the surface of the belt, without increasing cost of adding a structure for changing the belt and without increasing workers' burden can be provided.

As the apparatus is constructed in such manner, the holding members for the supporting rollers 40A, 40B support the supporting roller 47 while they are movable in the running direction of the intermediate transfer belt 45 of the belt supporting frame 51 by the spring 41A in the groove provided in the unit body 54. The intermediate transfer belt 45 is stretched by applying tension with the supporting roller 47 that is held by pressing with the spring 41A.

As shown in FIG. 5 and FIG. 6, the belt supporting frame 51 is composed so as to be capable of separating into a plurality parts such as two unit bodies 53 and 54 to the direction perpendicular to the transporting direction of the intermediate transfer belt 45. Furthermore, tow unit bodies 53 and 54 have the driving roller 46, the supporting roller 47 and the backup roller 48. The unit bodies 53, 54 of the belt supporting frame 51 are capable of bending to the straining direction of the endless belt i.e. to such direction as the whole outer circumference of the belt supporting frame is shorter than the inner circumference of the intermediate transfer belt 45 as the supporting point for bending is on the valley side whereby the intermediate transfer belt 45 can be mounted to the supporting frame 51 even if the guide members 24A, 24B, 25A and 25B for protecting the edge of the intermediate transfer belt are attached.

In this way, the guide members 25A, 25B, 24A, 24B can be unified together with the belt supporting frame so as to reduce number of component parts of the apparatus and fluctuation owning to assembling, which results in stable quality products. As the belt is easily mounted and removed, time is savable not only when mounting but also when displacing so that the supporting frame becomes easier to recycle.

As shown in FIG. 6, one side of the opening of the intermediate transfer belt 45 is opened as a triangle form by holding with an unshown guide and the belt supporting frame 51 can be inserted from the other side of the opening. It may also be possible that an endless intermediate transfer belt or an endless belt is opened triangularly, equilateral-triangularly or elliptically and erected on one side while the supporting frame 51 is inserted from the other side of the opening.

FIG. 5 and FIG. 6 show the case in which the supporting frame 51 is split into the two unit bodies. As a matter of fact, the frame may be split into more than two unit bodies. Though the figure shows a case of the unit body 53 having the driving roller 46, the unit body 54 having the supporting roller and the backup roller 48, structure is apparently not restricted to such embodiment so long as the belt can be supported.

Since the structure of the supporting frame 51 is restricted like this, it is unnecessary for a tension roller to be movable like a conventional apparatus so that the outer circumference of the surface of the belt supporting frame which contacts the belt is smaller than the inner circumference of the belt; it is unnecessary to support the belt by a supporting member for changing the belt; it is unnecessary to provide a cartridge for replacing the belt from the driving roller; it is unnecessary to fit the outer circumference of the surface of the belt supporting frame which contacts the belt with the inner circumference of the belt by getting the outer circumference of the surface of the belt supporting frame shorter than the inner circumference of the belt and disposing the tension roller apart from the belt supporting frame. As a result, an image forming apparatus having a low cost frame capable of easily and simply mounting and replacing without damaging the surface of the belt, without increasing cost of adding a structure for changing the belt and without increasing workers' burden can be provided.

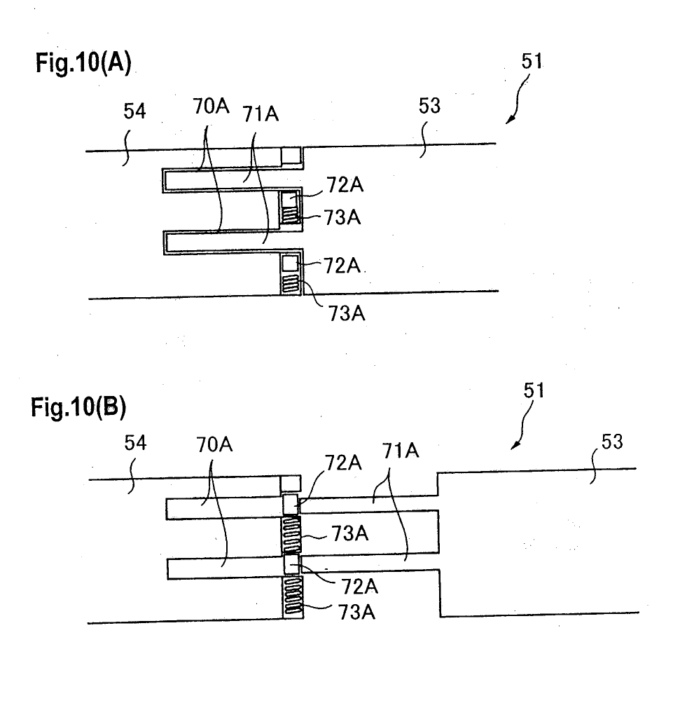

As explained above, the unit bodies 53, 54 are bent so as to get the whole outer circumference of the supporting frame shorter than the inner circumference of the intermediate transfer belt. Not exclusively by bending, the length of the belt supporting frame 51 may be capable of varying in the belt transporting direction as shown in FIG. 10. FIG. 10 is a sectional view of a variable length structure of the belt supporting frame 51 showing a lateral face of belt transporting plane edge of the belt supporting frame. One of the unit bodies 53, 54 of the belt supporting frame contacting each other, e.g. the unit body 53 is provided with a protruded part 71A and the other unit body 54 is provided with a recessed part 70A which receive the protruded part 71A while a fixing member 72A for fixing the protruded part 71A and a spring 73A for pressing upward the fixing member 72A at the open end side of the recessed part 70A. In the variable length in the belt transporting direction structure, when the endless belt is mounted to or removed from the supporting frame 51, the endless belt is mounted as the fixing member 72A fixing the protruded part 71A is pressed down against the force of the spring 73A to embed the protruded part 71A to the recessed part 70A and the length in the belt transporting direction of the belt supporting frame is shortened to mount the endless belt. After that, when said protruded part 71A is drawn from the recessed part 70A, said fixing member occupy the recessed part 70A to fix the protruded part 71A and the belt supporting frame 51 becomes a predetermined length.

In this way, relationship that an outer circumference of the belt supporting frame is shorter than an inner circumference of the belt is easily obtained without bending the unit bodies whereby a costly mechanism for exchanging a belt need not to be added, a burden of worker does not increase and the surface of the belt is not damaged so as to be able to easily and simply mount or remove the belt. Thus, an image forming apparatus having a low cost belt supporting frame can be provided. Though this embodiment is explained by FIG. 10 of a sectional view showing the lateral face in the edge direction of the belt transporting face, it is needless to say the structure may be a structure of the belt transporting face.

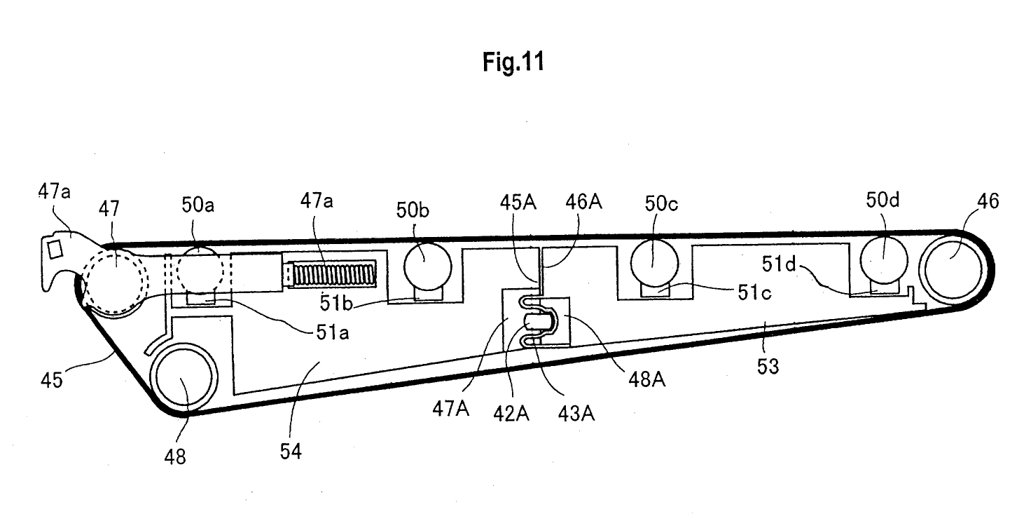

Another embodiment of a belt unit is now explained as follows. The same constituent element as the constituent element in FIG. 5-FIG. 10 is numbered with the same number. As shown in FIG. 11, a belt unit has a supporting roller holding member 47a which holds a supporting roller 47 and is movable in the running direction of an intermediate transfer belt 45 in a belt supporting frame 51 by a groove provided in a unit body 54 and is pressed by a spring 47b so that the held supporting roller applies tension to the intermediate transfer belt 45 to stretch the intermediate transfer belt. Since other elements and actions are explained in FIG. 5-FIG. 10, repeated explanations are omitted.

Though the embodiment according to the present invention is applied to an apparatus using an endless intermediate transfer belt in the preceding explanation, an endless belt like an aforementioned one is used as a belt of a photosensitive body drum or a belt in a transporting device of a last transfer member. When the belt according to the present invention is applied to such apparatuses, the same effect is apparently obtained.

The belt unit explained in FIG. 5-FIG. 10 can be added a cleaning device for cleaning residual toner of the intermediate transfer belt.

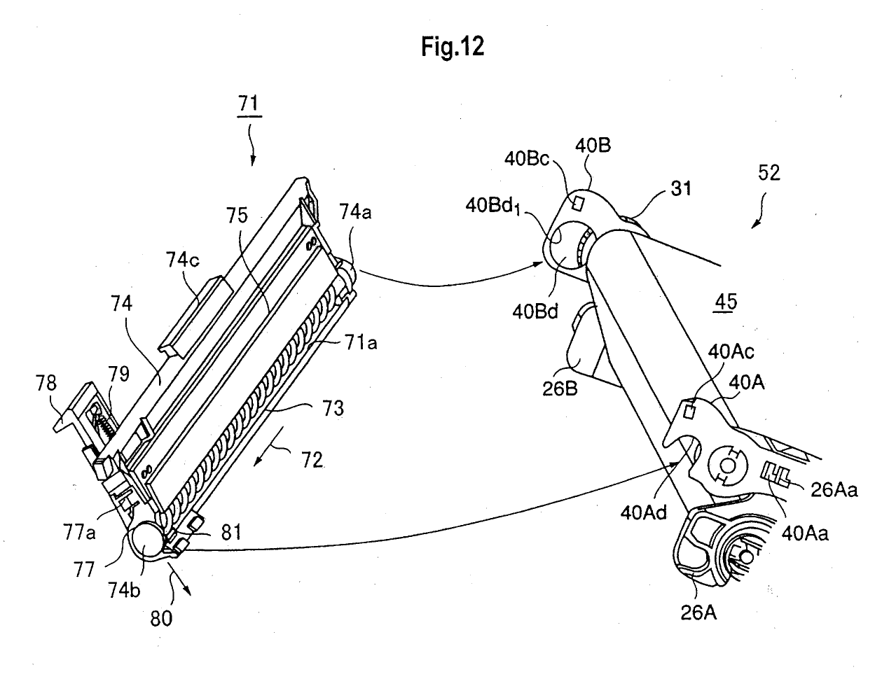

Referring to FIG. 12-FIG. 15, the procedure for mounting a cleaning device to the belt unit 51 is explained. As shown in FIG. 12, a cleaning device 71 has a half cylindrical vacant space (screw chamber) 71a in which a frame 74 rotatably having a screw 73 capable of transporting waste toner into the vacant space 71a in the direction of the arrow headed line is disposed and a blade 75 which scrapes residual toner on the intermediate transfer belt 45 by moving of the intermediate transfer belt is disposed at the upper part of the opening of the vacant space 71a.

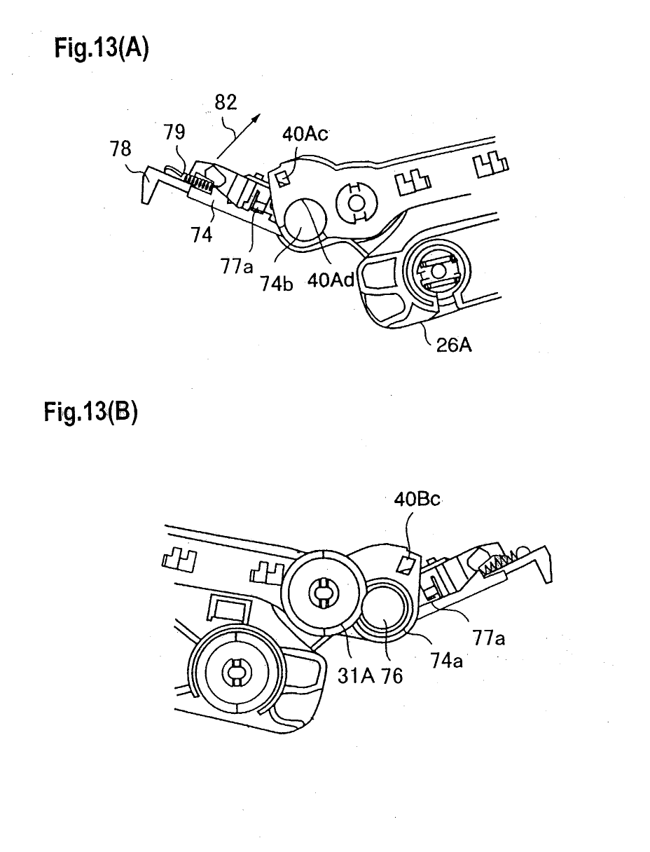

A flange part 74a having an opening coaxial with a rotational axis of the screw 73 is disposed projectingly. A gear 76 which connects to the screw 73 through the opening is disposed, as shown in FIG. 13(B).

A round protrusion 74b is provided coaxially with the screw 73. A metal fixing chip 77a is provided in the vicinity of the round protrusion integrally with the frame 74. The fixing part 77 rises on the fixing chip 77a. A fixing part 77 (FIG. 13(A)) is also provided on the side of the flange part 74a at a position corresponding to the fixing chip 77a (FIG. 13(A)).

An open and shut member 78 is provided capably of seesaw movement on the opposite face to the blade 75 of the frame 74. A spring is provided so as to press the open and shut member 78 downward. A shielding member (not shown) of an opening part 81 by which waste toner is rendered to drop in the direction of the arrow headed line 80 is provided at the lower end of the open and shut member 78. Toner in the screw chamber 71a is prevented to drop by shutting an opening 81 during the cleaning device 71 is not attached in the image forming apparatus.

Next, a method for mounting thus composed cleaning device to the belt unit 51 is explained as follows.

As shown in FIG. 12, the flange part 74a of the frame 74 is fitted in a circular opening 40Bd of the supporting roller holding member 40B and inserted as turning circumferentially so that a gear 76 (FIG. 13(B)) of the screw 73 engages a gear 31A of the supporting roller 47. A round protrusion 74b provided coaxially with the screw 73 is fitted and inserted into a half circular opening 40Ad of the supporting roller holding member 40A to become the state shown in FIG. 13.

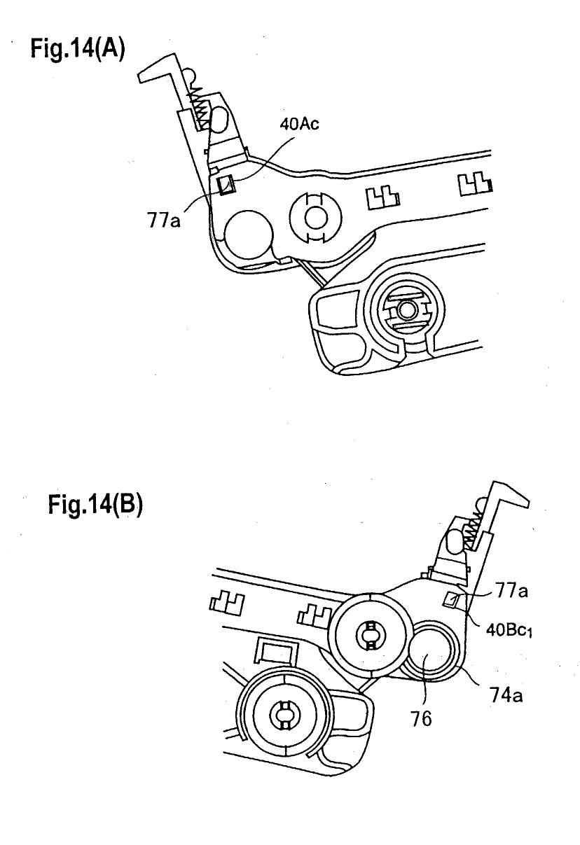

FIG. 13(A) shows an obverse side view of FIG. 12 and FIG. 13(B) shows a reverse side view of FIG. 12. From the state shown in FIGS. 13(A), (B), the frame 74 is turned in the arrow 82 direction so as to fit the fixing part 77a to a positioning hole 40Ac of the supporting roller holding member 40A and fit the fixing part 77a to a positioning hole 40Bc of the supporting roller holding member 40B, then the state shown in FIGS. 14(A), (B) are obtained.

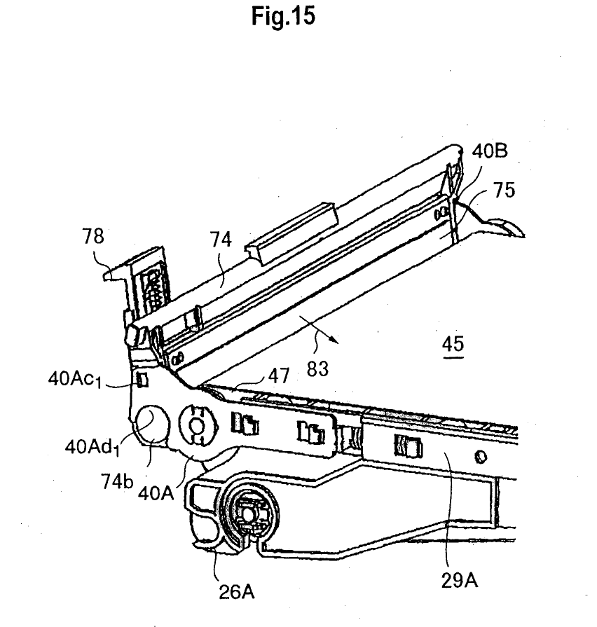

When this state is viewed in the perspective view shown in FIG. 15, the front edge of the blade 75 contacts the surface of the intermediate transfer belt 45 on the supporting roller 47. A side 40AC1 of the positioning hole 40Ac fixes the fixing part 77a facing the direction 83 of pressing the belt circumference of the blade 75 and a left lateral brim 40Ad1 of the half circular opening 40Ad as a supporting face supports a rotational axis part of a round protrusion. Since, likewise at the side of the supporting roller holding member 40B, a side 40Bc1 of the opening part 40Bc fixes the fixing part 77a (FIG. 14(B)) and a left lateral brim 40Bd1 of the circular opening 40Bd as a supporting face supports a rotational axis part of a round protrusion so as to fix the position of the blade 75. (See FIG. 12)

Hence, a frame is provided on a tension roller holding member which rotatably holds the supporting roller 47 in such a manner that the frame is turnable about the rotational axis of the screw; a blade for scraping waste toner is provided on the frame; an opening fitting to a protruding fixing part provided on the frame is provided on a tension roller holding member; whereby without a bothersome operation such as fixing with screws, the blade is fixed to a predetermined position by turning the frame around the rotating axis of the screw to fit the opening to the fixing part at the predetermined position. That is, first a pressing position of the blade on the circumference surface of the endless belt is found beforehand, and then a position of the fixing part 77a corresponding to the positioning holes 40Ac, 40Bc of said pressing position is found. Based on the data, each member is made whereby positioning of the blade is done by two steps fixing actions of a first fixing action of fitting the round protrusion 74b of the cleaning frame and flange part 74c to the openings 40Ad, 40Bd and a second fixing action of fixing the fixing part 77a to the positioning holes 40Ac, 40Bc, which results in cleaning smoothly by preventing fluctuation of a load on the blade edge to the surface of the belt.

As the supporting roller holding members 40A, 40B hold the supporting roller 47 and cleaning device 71 with the same member and are pressed to a tension direction by spring 41A, the supporting roller holding members 40A, 40B are capable of moving lineally as keeping a position where the blade 75 contacts to the intermediate transfer belt 45 from the cleaning device 45 constant distance without varying a contact state of the blade 75 to the intermediate transfer belt 45 tensioned by the supporting roller 47.

Hence, since the endless belt can be tensioned by pressing the supporting roller 47 by the spring 41A even if each member such as a tension roller fixing axis position, a driving roller axis position, an endless belt or others has a manufacturing error or even if a dimension of the endless belt is varied from a standard value by varying a tensile strength of a material of the endless belt itself owing to manufacturing error or deterioration with age, the error can be cancelled by moving the supporting roller holding members 40A, 40B linearly while keeping the position where the blade 75 contacts the intermediate transfer belt constant distance even though a position of the supporting roller holding members 40A, 40B varies in the tension direction.

In the intermediate transfer belt unit 52 provided with the cleaning device 71 as stated above, when the intermediate transfer belt turns, waste toner is scraped by the blade 75 and is discharged from the opening by rotating the gear 76 which engages the gear 31A by rotating the supporting roller 47 by the intermediate transfer belt 45.

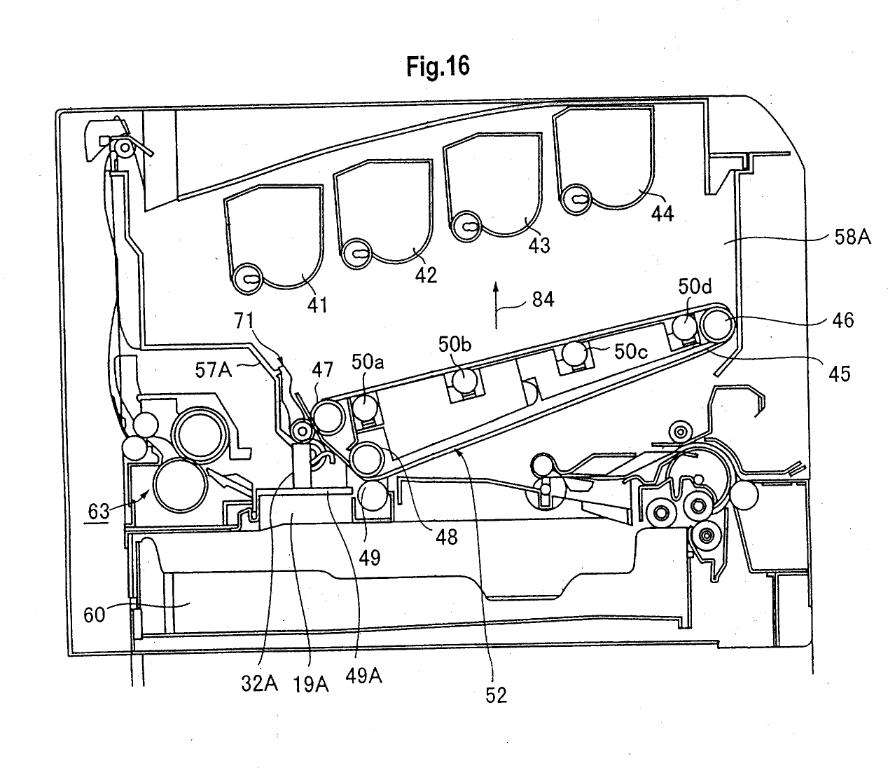

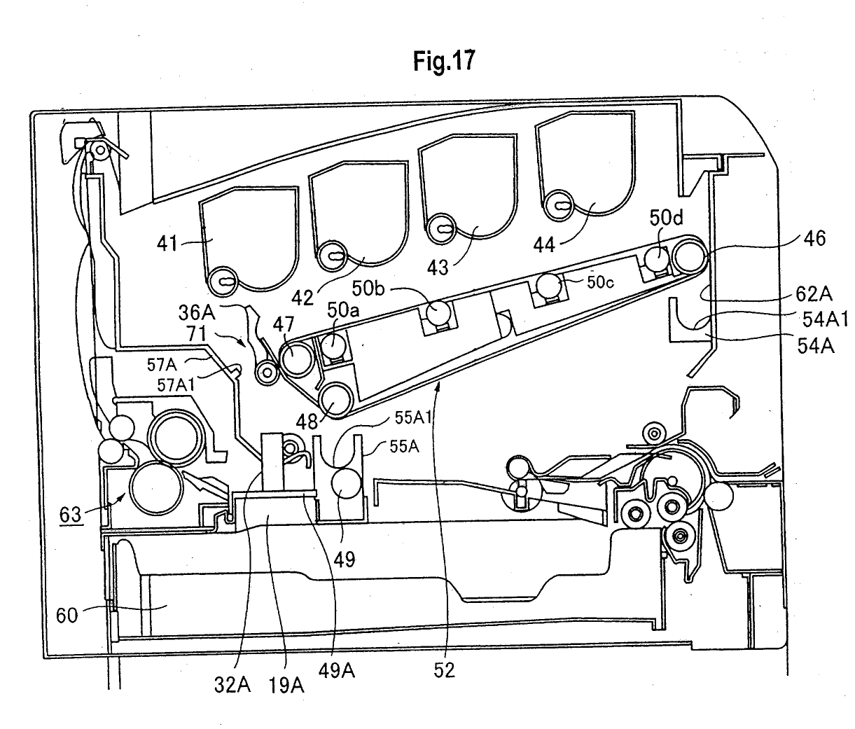

Referring to FIG. 2, FIG. 16 and FIG. 17, an intermediate transfer belt unit 52 provided with a cleaning device 71 is explained.

When an image forming units 41a-44a are separated from the surface of the intermediate transfer belt 45 to take out the image forming units 41a-44a as shown in FIG. 2, a opening part 58A is generated as shown in FIG. 16. When the belt unit is lifted up in the arrow 84 direction with an unshown gripping means being provided on the intermediate transfer belt unit 52, the downward end of an open shut member 78, which opens an opening 81 of a discharging port of waste toner in the screw chamber 71a of the cleaning device 71, is closed by a spring 79. And the belt unit 52 is lifted at the state that the open shut member 78 closes the opening 81 as shown in FIG. 17.

Meanwhile, a first guide 54A having a U-shaped guide face which connects to a guide wall 62A and a second guide 55A are provided on a main body of the image forming apparatus. A protruded part (not shown) of the first guide 54A capable of fitting to the U-shaped guide face of the first guide is provided coaxially with a driving roller 46. Likewise, a protruded part (not shown) of the second guide capable of fitting to the U-shaped guide face of the second guide 55A is provided coaxially with a backup roller 48.

Hence, when the protruded parts of the first and the second guide are separated, the belt unit 52 is easily taken out of the main body of the image forming apparatus.

In order that the belt unit 52 is mounted on the main body of the image forming apparatus, as shown in FIG. 17 the right side of the protruded part of the first guide is contacted to the guide wall 62A and the belt unit 52 is lowered, then the protruded part of the first and the second guide on the belt unit 52 side are fitted to the U-shaped guide faces of the first guide 54A and the second guide 55A on the main body of the image forming apparatus so that the belt unit 52 is mounted on mounting stages 54A1, 55A1.

The open shut member 78 contacts with a protrusion 57A1 of the insulating wall 57A and opens an opening part 81 facing the opening of a waste toner pipe 32A, which results in the state shown in FIG. 2.

In this way, the belt unit is composed by disposing the unit body to which the endless belt is mounted at stretched state on upper and under plane thereof and providing a protective member having a supporting member higher than the surface of the endless belt on the both lateral sides in the running direction of the endless belt of the unit body. A receiving part under side of which receives the protective member and upper side of which is opened is formed on the main body of the image forming apparatus and further a guide which enables the belt unit to be mounted at a predetermined position is provided. The belt unit has the protective member which prevent the endless belt to be damaged by griding with other members even when the belt unit is mounted out of the image forming apparatus or is inserted to the main body side of the image forming apparatus in the axis directions of many kinds of rollers.

At least in the state that the photosensitive bodies are removed, the belt unit is mounted or removed by handling of mounting and removing the belt unit to and from the image forming apparatus in the axis directions of many kinds of rollers and by handling of gliding the belt unit in the direction different from the direction of the handling of mounting and removing with the guide.

When the belt unit of the image forming apparatus is drawn out in the axis directions of many kinds of rollers, in order to prevent damage by griding the upper surface of the endless belt with the photosensitive bodies, the developing devices or others, appropriate distances between the both of them are necessary.

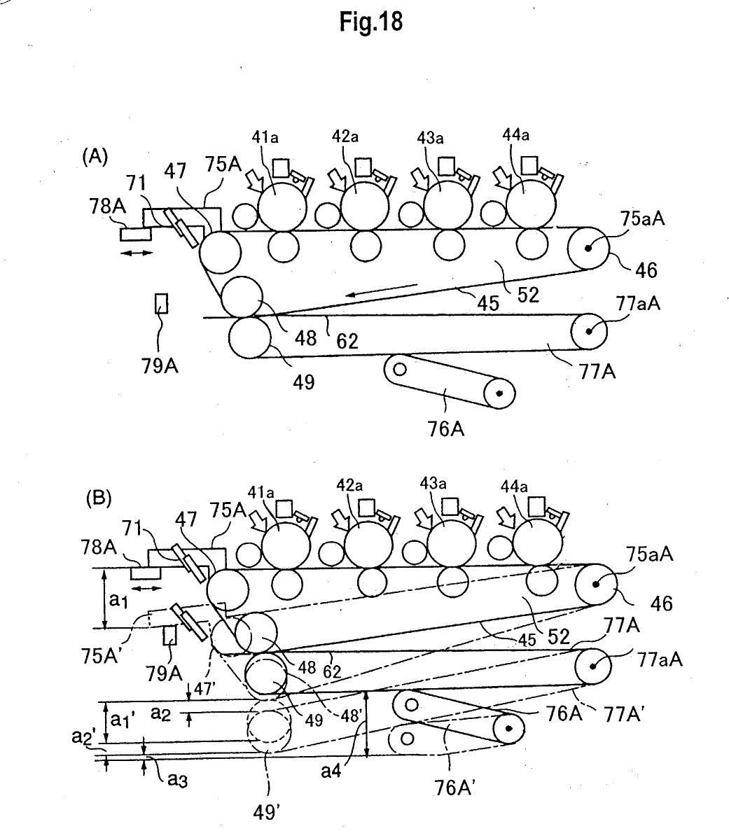

As shown in FIG. 18, a side panel 75A, which is a constituent of a belt supporting unit (belt unit) 52 is capable of turning about 75aA between a device position fixed by a fixing member 78A disposed movably left and right by handling and a departing position fixed by a fixing member 79A and capable of drawing to front. At the state of (A), a counterclockwise turning is blocked by the fixing member 78A while the endless belt 45 contacts the photosensitive body.

A transporting unit 77A is capable of turning about 77aA. At the state of (A), an anticlockwise turning is blocked by a fixing lever 76A while the endless belt 45 contacts a secondary transfer roller 46.

By such structure, when a photosensitive body drum is disposed on the upper surface of the belt unit 52, belt unit 52 needs to be moved apart downward for an appropriate distance a1 in order not to contact the endless belt 45 with the photosensitive body drum while a transporting unit needs to be moved downward in order to set apart for an appropriate distance a2 between the transporting unit 77A and the belt unit 52. With this regard, the transporting unit 77A needs to be moved downward for a distance a1′ corresponding to the distance a1 and for a distance a2′ corresponding to the distance a2.

As the fixing lever 76A controlling up and down movement of the transporting unit 77A is disposed under the transporting unit 77A, a moving zone a4 is necessary under the transporting unit 77A for moving the transporting unit 77A up and down. A protrusion a3 on the side of the dashed line of the fixing lever 76A is further necessary.

Therefore, the transporting unit 77A needs the space of the sum of the distance a1′+a2′ and the protruded distance of the fixing lever a3, that is a1′+a2′+a3 under the transporting unit 77A.

Meanwhile, as shown in FIGS. 2, 16 and 17, if a photosensitive body drum, a developing device and others are drawn apart from the belt unit 52 for the distance a1, the space where the photosensitive body drum, the developing device and others are disposed remains as a opening part 58A. Then, when the belt unit 52A is lifted up toward the opening part 58A and is drawn to front, the appropriate distance a2′, the fixing lever 76A and the protrusion for the fixing lever 76A are unnecessary. Eventually, the space (a2′+a3+W) including the capacity (W) for the fixing lever 76 is unnecessary, which results in capability of providing a compact and easy-to-handle image forming apparatus.

Though the embodiment using the endless intermediate transfer belt according to the present invention is explained above, since an endless belt is used as a photosensitive body or transporting device for a last transporting member, the embodiment can be also applied to such devices to obtain the same advantage.

And though in the embodiment above, the blade 75 is used for scraping waste toner, a fur blush can be beyond controversy used as an alternative.

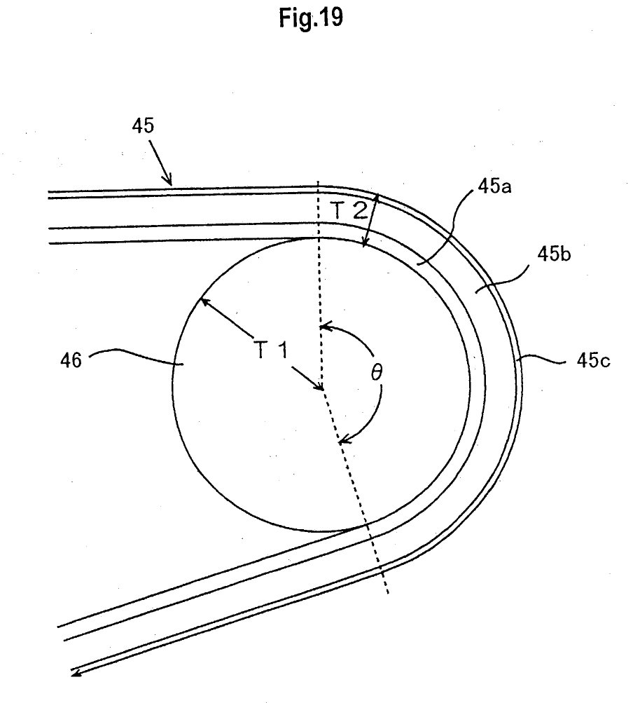

An intermediate transfer belt 45 is now explained below as for its structure. Referring to FIG. 19, the intermediate transfer belt 45 comprises a base material layer 45a, an elastic material layer 45b and a releasing material layer 45c. A small elongation of the base material layer 45a of the intermediate transfer belt 45 absorbs a shock generated at the time of starting to drive; an elongation of the elastic material layer 45b and a releasing material layer 45c absorbs a distortion generated by a maximum curvature of the driving roller 46 whereby the belt has a good durability and a measure for color drift or image defects such as an image without midsection. Further, a stable transferring is possible by setting a volume resistivity of the intermediate transfer belt 45 larger toward the surface layer.

As for the base material layer 45a, a film material having a thickness of 50 μm to 150 μm and a resistivity of 10¹⁰ Ωcm is favorable. Further, because the base material layer 45a is required a function to communicate accurately the rotational energy from the driveling roller 46, a strength is necessary so that a ratio of an elongation before the intermediate transfer belt is communicated with the driving force of the driving roller to an elongation after it leaves the driving roller is preferably 1-10%. A material such as polycarbonate (PC), nylon (PA), polyester (PET), polysulphon (PSU), poyethersulphon (PEI), polyetherketon (PEEK), thermoplastic polyimid (TPI), thermosetting polyimid (PI), polyvinylidenefluoride or etylene-tetrafluoroetylene copolymer can be used as a material of the base material layer. The base material layer can be formed by a method such as inflation or extrusion adding an electrically conductive material such as carbon black to the material above.

As for the elastic material layer 45b, a rubber material such as styrene-butadiene rubber, butadiene rubber, ethylene-propylene rubber, chloroprene rubber, acrylonitrile-butadiene rubber, fluoropolymer rubber or polyurethan rubber can be used. A material having a predetermined resistivity can be obtained by adding an electrically conductive material such as carbon black, aluminum powder, nickel powder or tin oxide powder to the aforementioned rubber material or also by adding an ionic additive or an electrically conductive resin to the aforementioned rubber material. One kind of aforementioned material with additives can be used or two or more than two kinds of materials with additives can be mixed for this usage. The thickness and elongation of the elastic material layer 45b is important for controlling formation of transfer nip, color drift or scattering of toner. Therefore the elastic material layer has a thickness of 100 μm-1000 μm more preferably 300 μm-700 μm and has preferably a ratio of an elongation before the intermediate transfer belt is communicated with the driving force of the driving roller to an elongation after it leaves the driving roller is preferably 2-10%. If the thickness is less than 100 μm, enough transfer nip can not be taken. If the thickness is greater than 1000 μm, it surpasses a range for use of the belt.

For the releasing material layer 45c of the most outer surface communicates softness of the elastic material layer 45b of the under layer to the surface of the photosensitive body drum, the layer is preferably softer and thinner. The thickness of the layer is preferably 3 μm-15 μm. If the thickness is less than 3, enough releasing effect as well as enough durability cannot be obtained. If the thickness is greater than 15, the elastic nature of the elastic material layer of the under layer is affected negatively so as not to be able to obtain enough transfer performance.

As for material of the releasing material layer 45c, a predetermined layer can be obtained by heating a material consisting of 40 parts of urethane resin binder dispersed with 60 parts of PTFE latex. As the releasing material layer 45c is the outer most surface of the intermediate transfer belt 45, a higher stability of elasticity than that of the elastic material layer 45b of the under layer is required. A typical fluorocarbon resin is polytetrafluoroethylene (PTFE), a copolymer of tetrafluoroethylene and hexa fluoropropyrene (PREP), and a copolymer of tetrafluoroethylene or perfluoroalkyl vinyl ether. These are used individually or as a mixture of two kinds or more. The releasing material layer is formed by such method as dipping method, roller coating method, doctor blade method, spray method or electrostatic coating method.

When the driving roller 46 has a sufficiently big diameter, the plastic deformation of the intermediate transfer belt needs not to be considered. As the diameter of the driving roller 46 become smaller, the intermediate transfer belt 45 receives a big distortion on the driving roller 46 so that crack or color drift is generated when used, causing degradation of the belt.

However, when the diameter of the roller becomes larger, a main body of the image forming apparatus eventually comes to big. For this reason, a roller having a diameter of less than 25 mm and a surface treated with ceramic particles and controlled to a surface roughness of Rz=1˜15 μm is used. If a surface roughness is 1 μm or greater, then stable transportation by the intermediate transfer belt is realized. If a surface roughness is 15 μm or greater, then it is unfavorable because the base material layer 45a which faces the roller is largely distorted and convexity and concavity are remained on the surface of the intermediate transfer belt to which a driving force is communicated because of concentrated stress to the ceramic particles.

It is favorable that a toner of non-magnetic type and TiO₂ treated with a lubricating treating agent for the porpoise of decreasing a friction of the surface of the intermediate transfer belt 45 are used as a developer material of the image forming apparatus using such intermediate transfer belt 45. The TiO₂ can be replenished as a part of transfer toner at the time of transferring and further at the time of developing for the porpoise of periodical cleaning to the intermediate transfer belt 45. A lubricating treating agent residing on the intermediate transfer belt 45 together with toner is coated on the surface of the releasing material layer 45c in cleaning process so as to prevent paper powder or toner ingredient adhering, to prevent image from deteriorating by absorbing water from humid environment and to enable stable rotation of the driving roller 46 of a small diameter by decreasing driving torque. Various fatty acids such as stearic acid and their metal salt or amide can be used as such lubricating agent.

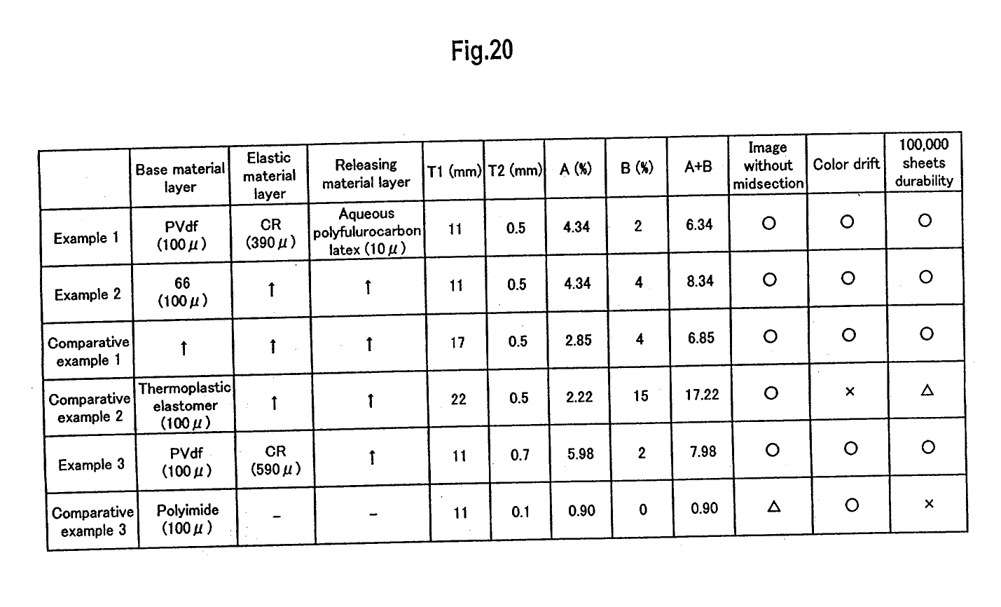

FIG. 20 shows an evaluated result varying a diameter of the driving roller 46, a material that is a constituent of the intermediate transfer belt or a thickness. In FIG. 20, each of base material layer, elastic material layer and releasing material layer corresponds to each of the base material layer 45a, the elastic material layer 45b and the releasing material layer 45c explained in FIG. 19 respectively. T1 is a radius of the driving roller 46 shown in FIG. 19; T2 is a whole thickness of the intermediate transfer belt 45; A is a ratio of an elongation of the outer diameter to that of the inner diameter of the part of the intermediate transfer belt 45 which contacts the driving roller 46. A relation of T1, T2, an angle θ of the part where the intermediate transfer belt 45 contacts the driving roller 46 and a ratio of elongation A is expressed as,

$$A = 100 \times \frac{2 π ( T1 + T2 ) - 2 π T1}{2 π ( T1 + T2 )} ( \% )$$

B is a percent ratio of an elongation before the intermediate transfer belt is communicated with the driving force of the driving roller to an elongation after it leaves the driving roller and can be found as a ratio of a running rate of the intermediate transfer belt 45 from the supporting roller 47 until the driving roller 46 to a running rate of the intermediate transfer belt 45 from the driving roller 46 until the backup roller 48. That is, a running rate from the supporting roller until the maximum bending point of the driving roller is greater than a running rate from the driving roller 46 until the maximum bending point of the backup roller 48 because of tensile force. Therefore, B is calculated by finding the ratio of them.

A+B expresses an elongation of the whole intermediate transfer belt 45 which is equal to an elongation A of the intermediate transfer belt 45 at the driving roller 46 added to a ratio of an elongation of the intermediate transfer belt 45 at before-and-after the driving roller 46. A column of “image without midsection” or “color drift” denotes a state of the image without midsection or the color drift at printing respectively. A column of “100,000 sheets durability” denotes stability when 100,000 sheets of paper are printed by the image forming apparatus shown in FIG. 3.

In “example 1”, film having a thickness of 100 μm was made for an endless resin belt by extruding polyfluorovynilidene (PVdF). The film was mounted the image forming apparatus for evaluation shown in FIG. 3. The apparatus was driven by the driving roller 46 having a diameter of 22 mm (T1 is 11 mm long). Measurements were made for a running rate of the film from the supporting roller 47 until the driving roller 46 and that from the driving roller 46 until the backup roller 48 shown in FIG. 3. A ratio calculated from resultant values of the rates was found to be 2% shown in the B column of FIG. 20. Chloroprene rubber of a thickness of 390 μm as a elastic material layer 45b was adhered to the polyfluorovynilidene (PVdF) film as a basic material layer shown in FIG. 19. Further, after polishing the surface of the rubber, the surface was coated with aqueous polyfluorocarbon latex at a thickness of 10 μm as a releasing material layer 45c and was cured at a temperature of 180° C. to be made as a composite belt. As a result, the thickness T2 of the intermediate transfer belt 45 was 500 μm and A was 4.34%. Since the most surficial releasing material layer 45c had elasticity more resilient than the elastic material layer 45b, the layer was not suffered by cracks caused by following the elongation of the elastic material layer 45b and all of “image without midsection”, “color drift” and “100,000 sheets durability” showed good results as shown in FIG. 20.

In “example 2”, nylon 66 having a thickness of 100 μm was used as an alternative of the base material layer 45a of polyfluorovynilidene (PVdF). Though B became 4, all of “image without midsection”, “color drift” and “100,000 sheets durability” showed the same good results as example 1.

In “example 3”, polyfluorovynilidene (PVdF) having a thickness of 100 μm similar to the example 1 was used as a base material layer 45a and the elastic material layer 45b of chloroprene rubber (CR) had a thickness of 590 μm. Accordingly, though T2 and A became 700 μm and 5.98 respectively, all of “image without midsection”, “color drift” and “100,000 sheets durability” showed the same good results as example 1 and 2.

In “comparative example 1”, the driving roller 46 having a radius (T1) of 17 mm was used. Nylon 66 having a thickness of 100 μm similar to example 2 as a base material layer 45a, chloroprene rubber (CR) having a thickness of 390 μm similar to example 1 as a elastic material layer 45b and aqueous polyfluorocarbon latex film having a thickness of 10 μm also similar to example 1 as a releasing layer 45c were used. B is the same as example 2. Because T1 became larger, A decreased to 2.85 and A+B also was reduced to 6.85 which were less than that of example 2. In the comparative example, all of “image without midsection”, “color drift” and “100,000 sheets durability” were good, however main body became larger because the radius of the driving roller 46 became larger to 17 mm.

Next, in comparative example 2, the driving roller 46 having a radius (T1) of 22 mm, the base material layer 45a of thermoplastic elastomer having a thickness of 100 μm similar to example 2, the elastic material layer 45b of chloroprene (CR) having a thickness of 390 μm similar to, example 1 and the releasing material layer 45c of aqueous polyfluorocarbon latex film having a thickness of 10 μm also similar to example 1 were used. A decreased to 2.22 because the radius T1 increased. B and A+B increased to 15 and 17.22 respectively because thermoplastic elastomer was used. On account of this, the elongation of the intermediate transfer belt 45 increased so that color drift was intense and 100,000 sheets durability marked Δ which indicated poor durability.

In last comparative example 3, the driving roller having a radius (T1) of 11 mm which was used in example 1-3 and the base material layer 45a of polyimide, which had very little elongation, having a thickness of 100 μm. The belt had no elastic material layer and no releasing material layer. On account of this, T2, A, B and A+B were 0.1, 0.90, 0 and 0.90 respectively, which resulted in image without midsection and poor durability.

As a result, in case of comparative example 3 which gives a value 0.90 of a minimum ratio A (%) of elongation of the outer diameter to the inner diameter at the contacting part of the intermediate transfer belt 45 to the driving roller 46, though image without midsection is generated, there is no problem concerning color drift. In other cases, good results are generally obtained. The minimum value is 2 to 3, preferably 3 or greater. Maximum value may be set as 6 to 7, since example 3 was 5.98. Hence it is found good result is generally obtained with a following range of A,

3<A<7 (2).

A percent difference B% of a length of stretched side of the belt driven and stretched by the driving roller to a length of non-stretched opposite side of the belt mainly affect color drift. In case of 0 in comparative example 3, a problem of 100,000 sheets durability has arisen. In case of 15 in comparative example 2, color drift is generated. Thus, it is found a good result is obtained within the range of 2-4%. As for color drift, since there is no problem even if the A value is 0.90 which is that of comparative example 3, a range of A can be adopted as 1<A<6. Thus, it is found a good result is generally obtained when A+B which expresses elongation of a whole intermediate transfer belt 45 falls in to within the following range,

3<A+B<10 (3).

As for a ratio of an elongation before the intermediate transfer belt 45 is communicated with the driving force of the driving roller 46 to an elongation after it leaves the driving roller 46 in the base material layer 45a, since minimum value of A in the intermediate transfer belt 45 is 2-3, minimum value needs to be 1 for satisfying the inequality (3) and since color drift is generated when elongation B is 15, maximum elongation needs to be about 10 for completely satisfying the inequality (3). The both results above lead to a satisfactory range of 1-10% in order to satisfy the both conditions.

As elongation of elastic material layer 45b is a dominant parameter and minimum elongation A is preferably 2-3, minimum value needs to be 2 for satisfying the inequality (3) and further completely satisfying set value can be obtained if the maximum value of elongation B is set as about 10.

About the similar extent of elongation to the base material layer 45a is needed for the elongation of the elastic material layer. In consideration of maximum value of 10 of elongation B of the base material layer 45a, elongation of the elastic material layer needs to be 2-10% so as to be obtained a range for satisfying the both conditions.

What is claimed is:

1. In an image forming apparatus having a plurality of image forming units each of which forms a toner image by developing an electrostatic latent image on an image bearing body provided in correspondence to each color and an intermediate transfer body which is transported along a predetermined transport pathway and to which the toner image is transferred in a primary transfer part as a primary transfer image wherein the image forming units is disposed along a primary transfer part and an image is formed by secondarily transferring the primary transferred image to a recording medium with secondary transfer roller at a secondary transferring position which exists downstream side of the primary transfer part, the image forming apparatus is characterized in that the transporting pathway of the primary transfer part is inclined upwardly in the direction from an image forming unit disposed at the most upstream point to an image forming unit disposed at the most downstream point, the primary transfer part further comprising a first roller which transports the intermediate transfer body, a second roller which gives a tension to the intermediate transfer body and a third roller which confronts the second roller at secondary transfer position, the intermediate transfer body unit comprising the intermediate transfer body, the first roller, the second roller and the third roller where the primary transfer part is defined between the first roller and the second roller.

2. An image forming apparatus according to claim 1 wherein the third roller is disposed vertically under the image forming unit disposed at the most upstream point.

3. An image forming apparatus according to claim 2 wherein the intermediate transfer body unit has a pressing member which presses the second roller toward the outward in the radius direction.

4. An image forming apparatus according to claim 3 wherein each of the image forming units is for yellow, magenta, cyan or black and the image-forming unit disposed at the most upstream point is for black.

5. An image forming apparatus comprising an endless belt and a belt unit provided with a belt supporting frame for supporting the endless belt in the streching direction wherein the belt supporting frame is separable into a plurality of units in the orthogonal direction to the transporting direction of the endless belt and each unit is connected and supported so that a connected part is capable of bending in the bending direction of the endless belt.

6. An image forming apparatus comprising a belt supporting unit having a supporting part with a higher supporting point than the surface of an endless belt at both lateral sides in the transporting direction of the endless belt, the supporting part protecting the edge of the endless belt wherein an area defined by outer peripheral line of the belt supporting unit which is projected from the lateral side of the supporting part at the bent position is smaller than an area formed by the circumference of the endless belt so as to enable to mount or detach the endless belt.

7. An image forming apparatus according to claim 6 further comprising a roller supporting member for supporting a tension roller provided at a supporting part, each supporting member and supporting part at a position of confronting each other having a catching female part and a male part capable of catching and fixing a position of the supporting member utilizing a travel restricting width in the tension direction of the tension roller wherein the catching female part and the male part catch and fix at a region of traveling in the tension direction of the tension roller, while the endless belt is extended between a driving roller which drives the endless belt and a supporting roller which gives the endless belt a tension and a roller supporting member which support the supporting roller is provided at the supporting part.

8. An image forming apparatus according to claim 5 wherein a supporting point of bending of the supporting frame is provided at a valley side and each unit body of the belt supporting frame has a vertical plane on the belt side of the supporting point of bending of the supporting frame so as to restrict a position between the unit bodies by mutually contacting the vertical planes of the unit bodies.

9. An image forming apparatus according to claim 5 wherein a supporting point of bending of the supporting frame is provided at a valley side, a receiving part of the supporting point for bending the unit body having a round part of supporting face when turning the supporting point and a groove part for embedding the supporting point, the supporting point having a round part of approximately the same curvature as the receiving part and a flat part which is embedded to the groove part so that the supporting point which deviates from the groove part turns in the round part of the receiving part of the supporting point.

10. An image forming apparatus according to claim 9 wherein a bending angle of the unit bodies is slightly smaller than an angle at which the supporting point departs from the round part of the receiving part of the supporting point.

11. An image forming apparatus comprising:
an endless belt; and
a belt supporting frame having a roller for supporting the endless belt in the streching direction, wherein the belt supporting frame is capable of separating into a plurality of units in the orthogonal direction to the transporting direction of the endless belt and each unit is connected so that a connected part is capable of expanding and contracting in the straining direction of the endless belt.

12. An image forming apparatus according to claim 11 wherein a protruded part is provided on one of the unit body of the belt supporting frame which contacts to the other unit body each other and a recessed part to which the protruded part is embedded is provided on the other unit body while a member for latching is provided on the opening side of the recessed part and the protruded part is embedded in the recessed part when the endless belt is contracted in the straining direction of the belt and the protruded part is drawn from the recessed part while latching the other protruded part by the member for latching whereby the belt supporting frame is capable of expanding and contracting.

13. An image forming apparatus according to claim 5 further comprising a cleaning mechanism having a cleaning member which cleans paper powder or toner pressed and remaining on the surface of the circumference of the endless belt wherein a rotational shaft part of the cleaning mechanism is detachably and rotatably attached to the supporting frame and a frame of the cleaning mechanism is turned with the rotation of the rotational shaft part so that the frame of the cleaning mechanism faces the belt supporting frame, fixing the both frames at a point where the cleaning member presses the surface of the circumference of the endless belt.

14. An image forming apparatus according to claim 13 wherein the frame of the cleaning mechanism is capable of turning parallel in the vicinity of or in contact with a wall of the belt supporting frame while a catching member is provided on one frame face of the both frames, the catching member being capable of deforming elastically and catching holes provided on the other frame at a position corresponding to the position of pressing the endless belt of the cleaning member.

15. An image forming apparatus according to claim 13 wherein holes which catch rotatably the rotational shaft part of the cleaning mechanism are provided as a circular hole and an arc opening, the arc having less than half circle and the holes are positioned so that a supporting face of the arc opening is opposed to a circumference surface pressing direction of the endless belt of the cleaning member.

16. An image forming apparatus according to claim 15 wherein a driving system for driving a screw discharging residual toner and being provided in the cleaning mechanism is connected to the rotational shaft part of the circular hole side.

17. An image forming apparatus according to claim 13 wherein an elastic force imparting device is provided to a shutter mechanism which opens and closes a discharge opening of waste toner on a side of a cleaning frame of the cleaning mechanism so as to keep an opening state of the shutter mechanism by pressing the elastic force imparting device to impart an elastic force with the apparatus itself or one of members that the apparatus itself has.

18. An image forming apparatus according to claim 17 wherein an opening position of the shutter is set by pressing the elastic force imparting device to impart an elastic force with the apparatus itself or one of members that the apparatus itself has and a closing of the shutter is possible to close the shutter by departing the apparatus itself or one of members that the apparatus itself has from the belt supporting unit while an elastic force imparted through the elastic force imparting device of the cleaning member is cancelled by closing the shutter.

19. An image forming apparatus according to claim 18 wherein the endless belt is an intermediate transfer belt to which a primary image formed on a photosensitive body is transferred and then the image on the endless belt is secondarily transferred to a recording medium.

20. An image forming apparatus according to claim 19 wherein the cleaning device which cleans wasted toner on the intermediate transfer belt is disposed at the position to be a heat insulating wall for the intermediate transfer belt against heat from the fixing device.

21. An image forming apparatus comprising:
an image bearing body which forms an image by an electro-photographic method;
an intermediate transfer belt which is rotated by a driving roller and transfers primarily the image on the image bearing body; and
a mechanism for secondarily transferring the image on the intermediate transfer belt to a final transfer member,
wherein the intermediate transfer belt has a plurality of elastic layers and when a percentage difference of a stretched length of an outer circumference of the intermediate transfer belt to an inner circumference thereof at a position of contact to the driving roller is A% and a percent difference of a length of stretched side of the belt driven and stretched by the driving roller to a length of non-stretched opposite side of the belt is B%, the intermediate transfer belt is configured so that ranges of A and A+B fall simultaneously into inequalities of 3<A<7 and 3<A+B<10.

22. An image forming apparatus according to claim 21 wherein a base material layer of the intermediate transfer belt is made so that the base material layer has a thickness of 50 μm or more and 150 μm or less and a percent difference of a length of the base material layer of stretched side of the belt driven and stretched by the driving roller to a length of the base material layer of non-stretched opposite side of the belt is 1-10%.

23. An image forming apparatus according to claim 22 wherein an elastic material layer which composes the intermediate transfer belt is made so that the thickness of the elastic material layer is 300 μm or more and 700 μm or less and a percent difference of a length of the elastic material layer of stretched side of the belt driven and stretched by the driving roller to a length of the elastic material layer of non-stretched opposite side of the belt is 2-10%.

24. An image forming apparatus according to claim 22 wherein a surface layer of the intermediate transfer belt contains fluorocarbon resin.

25. An image forming apparatus according to claim 22 wherein the driving roller is made of metal and has a diameter of 25 mm or less, the surface of which is treated with ceramic particles which do not perform plastic deformation and has a surface roughness of Rz=1-15 μm.
